(19) United States
(12) Patent Application Publication
(10) Pub. No.: US 2024/0057599 A1
(43) Pub. Date: Feb. 22, 2024

(54) METHODS FOR IMPROVING FRUIT QUALITY

(71) Applicant: The State of Israel, Ministry of Agriculture & Rural Development, Agricultural Research Organization, Rishon Lezion (IL)

(72) Inventors: Noam ALKAN, Kidron (IL); Michal OREN-SHAMIR, Rehovot (IL); Yigal ELAD, Ganey Tikqva (IL); Dalia MAURER, Holon (IL); Oleg FEYGENBERG, Holon (IL)

(21) Appl. No.: 18/271,008

(22) PCT Filed: Jan. 6, 2022
(86) PCT No.: PCT/IL2022/050027

§ 371 Date: Jul. 5, 2023

Related U.S. Application Data
(60) Provisional application No. 63/164,051, filed on Mar. 22, 2021.
(60) Provisional application No. 63/134,403, filed on Jan. 6, 2021.

(51) Int. Cl. A01N 37/44; A01P 15/00; A23B 7/154; A23L 3/3526

(52) U.S. Cl. CPC A01N 37/44; A01P 15/00; A23B 7/154; A23L 3/3526

(57) ABSTRACT

The present invention is directed to methods for improving flavor, coloration, curing, or any combination thereof, of a plant material, including pre-harvest or post-harvest treatment with an effective amount of an aromatic amino acid or an analog thereof.

### CROSS-REFERENCE TO RELATED APPLICATION

This application claims the benefit of priority of U.S. Provisional Patent Application No. 63/134,403, titled “METHODS FOR IMPROVING FRUIT QUALITY”, filed Jan. 6, 2021, and of U.S. Provisional Patent Application No. 63/164,051, titled “METHODS FOR IMPROVING FRUIT QUALITY”, filed Mar. 22, 2021. The contents of both applications are incorporated herein by reference in their entirety.

### FIELD OF THE INVENTION

The present invention, in some embodiments thereof, relates to a method of improving plant quality, e.g., flavor, coloration, wound curing, or a combination thereof.

### BACKGROUND

It is generally accepted that the flavor quality of many fruits has significantly declined over recent decades. It seems that this decline, at least partially, may be attributed to an early harvest, injuries, long storage, and biased selection of somewhat desired phenotypes, e.g., duration of shelf life, and firmness, that at least in some cases are in inverse correlation with flavor, aroma, nutritional values, coloration, etc. Flavor involves the integration of sugars, acids, and volatile organic compounds (VOCs).

There is a great need for methods for improving fruit quality parameters, such as flavor, aroma, wound curing, coloration, or their combination. Further, how and when to select a fruit that is suitable for quality improvement treatment is currently undetermined.

### SUMMARY

According to a first aspect, there is provided a method for improving any one of: flavor, coloration, curing to damage, or a combination thereof, of a plant material, foliage of a plant comprising said plant material, or both, comprising pre-harvest or post-harvest treating a plant material with an effective amount of phenylalanine or an analog thereof.

In some embodiments, improving does not comprise increasing due to a reduction in any one of: flavor, coloration, curing, or a combination thereof, being induced by a plant pathogen.

In some embodiments, improving flavor comprises: increasing the amount of anthocyanin, flavonoid, or both, in the plant material or a juice extracted therefrom.

In some embodiments, improving flavor comprises: increasing Brix value, reducing acidity value, increasing aroma, or both, in the plant material or a juice extracted therefrom.

In some embodiments, improving coloration comprises inducing red coloration, reducing the amount of chlorophyll, increasing the ratio of anthocyanin to chlorophyll, or any combination thereof, in the plant material.

In some embodiments, the plant material comprises anyone of fruit or tuber.

In some embodiments, the damage is induced by an abiotic agent.

In some embodiments, the abiotic agent comprises a physical or a mechanical injury.

In some embodiments, the improving the curing comprises: increasing scratch curing, increasing cut curing, increasing scratch color curing, reducing weight loss %, increasing lignin production rate or suberin production rate or both, or any combination thereof, of the plant material.

In some embodiments, the effective amount of phenylalanine or an analog thereof is above 2 mM.

In some embodiments, the effective amount of phenylalanine or an analog thereof ranges from 4 mM to 20 mM.

In some embodiments, the method further comprises a step of providing a preharvest abiotic stress condition to the plant material for a period of time ranging from 1 to 30 days.

In some embodiments, the abiotic stress condition comprises light, radiation, temperature, lack of nutrient or water, or any combination thereof.

In some embodiments, the method further comprises a step of selecting a plant material in need of a treatment using said phenylalanine or an analog thereof.

In some embodiments, selecting comprises determining an amount of a phytochemical in the plant material compared to a predetermined threshold, wherein a plant material comprising the phytochemical in an amount greater than the predetermined threshold is suitable for pre-harvest or post-harvesting treating with an effective amount of phenylalanine or an analog thereof.

In some embodiments, the phytochemical is selected from the group consisting of: a flavonoid, an anthocyanin, a pigment, and any combination thereof.

In some embodiments, the pigment comprises chlorophyll.

In some embodiments, selecting comprises determining total soluble solids (TSS) % or dry matter, or TSS/Acid in the fruit, wherein a fruit comprising at least 5% less TSS % or TSS/Acid, is suitable for pre-harvest or post-harvest treating with an effective amount of phenylalanine or an analog thereof.

In some embodiments, treating comprises: drenching, dipping, soaking, injecting, spraying, coating, or any combination thereof.

In some embodiments, treating is in: an open field, a greenhouse, a storage facility, or any combination thereof.

In some embodiments, improving is compared to control plant material.

In some embodiments, the plant material comprises a vegetable or fruit.

In some embodiments, the vegetable comprises: a stalk, a leaf, a root tuber, a stem tuber, or any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 includes micrographs and graphs showing improvement of flavor in mango fruits (“Shelly”) by postharvest application of Phe in an experiment conducted in 2019 during 15 days of storage at 22° C.

FIG. 2 includes micrographs and graphs showing improvement of flavor in mango fruits (“Shelly”) by postharvest application of Phe in an experiment conducted in 2020 during 13 days of storage at 22° C.

FIG. 3 includes micrographs and graphs showing improvement of flavor in mango fruits (“Tali”) by postharvest application of Phe in an experiment conducted in 2020 during 12 days of storage at 22° C.

FIG. 4 includes representative pictures showing induction of red coloration (e.g., blushing) in mango fruits (“Shelly”) by preharvest application of Phe. Control—untreated; 1 W Phe—1 week preharvest of phenylalanine treatment; 2 W Phe—2 weeks preharvest of phenylalanine treatment; and 2 W PDJ—2 weeks preharvest of prohydrojasmon treatment.

FIG. 5 includes vertical bar graphs showing induction of red coloration (e.g., blushing) in mango fruits (“Shelly”) by preharvest application of Phe. T-0—Harvest; CS—after cold storage; SL—after shelf life. Surface area of the red color was evaluated as percentage, and red intensity was evaluated on a scale of 0-5. Each mango fruit was assessed for percentage of red surface area on fruit for each treatment at different time points (harvest, and after shelf life at 22° C.). Similarly, red intensity was evaluated for each mango fruit using a visual rating scale, where 0=no red color, 1=faint red color, and 5=very intense red color. Fifty fruit were evaluated per treatment. The skin color (hue and a*) of 15 mango fruit was measured for each treatment using a CR-400/410 Chromometer (Konicka Minolta, Osaka, Japan) on the equatorial line of each fruit at the reddest point.

FIG. 6 includes vertical bar graphs showing induction of red coloration (e.g., blushing) in mango fruits (“Shelly”) by preharvest application of Phe. T-0—Harvest; CS—after cold storage; SL—after shelf life. Chlorophyll, anthocyanin, and flavonoid content were measured by the Multiplex III fluorescence detector (Force A, Orsay, France), which consists of 12 fluorescence signals. The ratios between these signals in different mathematical expressions were interrelated to the fluorescence of major chemical groups, e.g., anthocyanin (FER_RG, the ratio of infra-red emission excited by red or green light), flavonoids (FLAN), and chlorophyll (SER_R). 15 fruits were evaluated for each treatment at the red side.

FIG. 7 includes micrographs and graphs showing flavor improvement of mango fruits (“Shelly”) after shelf life by preharvest application of Phe in an experiment conducted in 2020.

FIG. 8 includes micrographs and graphs showing quality improvement of juice extracted from mango fruits (“Shelly”) by preharvest application of Phe in an experiment conducted in 2020.

FIG. 9 includes representative pictures showing induction of red coloration (e.g., blushing) in mango fruits (“Kent”) by preharvest application of Phe. Control—untreated; 1 W Phe—1 week of preharvest phenylalanine treatment; 2 W Phe—2 weeks of preharvest phenylalanine treatment; and 2 W PDJ—2 weeks of preharvest prohydrojasmon treatment.

FIG. 10 includes vertical bar graphs showing induction of red coloration (e.g., blushing) in mango fruits (“Kent”) by preharvest application of Phe. T-0—Harvest; CS—after cold storage; SL—after shelf life. Surface area of the red color was evaluated as percentage, and red intensity was evaluated on a scale of 0-5. Each mango fruit was assessed for percentage of red surface area on fruit for each treatment at different time points (harvest, and after shelf life at 22° C.). Similarly, red intensity was evaluated for each mango fruit using a visual rating scale, where 0=no red color, 1=faint red color, and 5=very intense red color. Fifty fruit were evaluated per treatment. The skin color (hue and a*) of 15 mango fruit was measured for each treatment using a CR-400/410 Chromometer (Konicka Minolta, Osaka, Japan) on the equatorial line of each fruit at the reddest point.

FIG. 11 includes vertical bar graphs showing induction of red coloration (e.g., blushing) in mango fruits (“Kent”) by preharvest application of Phe. T-0—Harvest; CS—after cold storage; SL—after shelf life. Chlorophyll, anthocyanin, and flavonoid content were measured by the Multiplex III fluorescence detector (Force A, Orsay, France), which consists of 12 fluorescence signals. The ratios between these signals in different mathematical expressions were interrelated to the fluorescence of major chemical groups, e.g., anthocyanin (FER_RG, the ratio of infra-red emission excited by red or green light), flavonoids (FLAN), and chlorophyll (SER_R). 15 fruits were evaluated for each treatment at the red side.

FIG. 12 includes micrographs and graphs showing flavor improvement of mango fruits (“Kent”) after shelf life by preharvest application of Phe in an experiment conducted in 2020.

FIG. 13 includes micrographs and graphs showing quality improvement of juice extracted from mango fruits (“Kent”) by preharvest application of Phe in an experiment conducted in 2020.

FIG. 14 includes graphs showing flavor improvement of white Muscat grapes by preharvest application of Phe in an experiment conducted in 2020.

FIG. 15 includes graphs showing quality improvement of juice extracted from white Muscat grapes by preharvest application of Phe in an experiment conducted in 2020.

FIG. 16 includes graphs showing quality improvement of juice extracted from Petit Verdot grapes by preharvest application of Phe in an experiment conducted in 2020.

FIG. 17 includes representative pictures showing induction of red coloration (e.g., blushing) in apple fruits (“Jonathan”) after cold storage by preharvest application of Phe. Control—untreated; 1 W Phe—1 week of preharvest phenylalanine treatment; 2 W Phe—2 weeks of preharvest phenylalanine treatment; and 2 W PDJ—2 weeks of preharvest prohydrojasmon treatment.

FIG. 18 includes vertical bar graphs showing induction of red coloration (e.g., blushing) in apple fruits (“Jonathan) by preharvest application of Phe. Surface area of the red color was evaluated as percentage, and red intensity was evaluated on a scale of 0-5. Each apple fruit was assessed for percentage of red surface area on fruit for each treatment at different time points (harvest, after cold storage at 0° C. and after shelf life at 22° C.). Similarly, red intensity was evaluated for each apple fruit using a visual rating scale, where 0=no red color, 1=faint red color, and 5=very intense red color. Fifty fruit were evaluated per treatment. The skin color (hue) of 30 mango fruit was measured for each treatment using a CR-400/410 Chromometer (Konicka Minolta, Osaka, Japan) on the equatorial line of each fruit at the reddest point.

FIG. 19 includes vertical bar graphs showing induction of red coloration (e.g., blushing) in apple fruits (“Jonathan”) by preharvest application of Phe. Chlorophyll, anthocyanin, and flavonoid content were measured by the Multiplex III fluorescence detector (Force A, Orsay, France), which consists of 12 fluorescence signals. The ratios between these signals in different mathematical expressions were interrelated to the fluorescence of major chemical groups, e.g., anthocyanin (ANTH_RG, the ratio of infra-red emission excited by red or green light), and chlorophyll (SER_R). 30 fruits were evaluated for each treatment at the red side.

FIG. 20 includes graphs showing flavor improvement of apple fruits (“Jonathan”) after cold storage by preharvest application of Phe.

FIG. 21 includes a graph showing flavor improvement of juice extracted from apple fruits (“Jonathan”) after preharvest application of Phe.

FIGS. 22A-22F includes vertical bar graphs and micrographs showing that postharvest treatment with phenylalanine induces scratch curing in potato tuber 7 days and 14 days post-treatment. Sifra potato scratch curing (22A); Sifra potato weight loss (22B); Memphis potato scratch curing (22C); Memphis potato weight loss (22D); and Memphis potato color curing (22E). (22F) Representative picture of skin analysis of control and Phenylalanine-treated Memphis potatoes 7 days after scratching.

FIGS. 23A-23D includes vertical bar graphs showing that postharvest treatment with phenylalanine induces cut curing in potato tuber 7 days and 14 days post-treatment. Sifra potato cut curing (23A); Sifra potato weight loss (23B); Memphis potato cut curing (23C); Memphis potato weight loss (23D).

FIGS. 24A-24E includes micrographs, fluorescent micrographs, and a vertical bar graph showing that postharvest treatment with phenylalanine induces cut curing in potato tuber 7 days post-treatment. (24A-24B) micrographs showing the Sifra potato curing of the cut in control (24A) and Phe treatment (24B) potatoes 7 days post-treatment. (24C-24D) fluorescent micrographs showing lignin dyed with Calcofluor white and photographed with a fluorescent microscope of a control (24C) and Phe treated (24D) potatoes. (24E) A graph showing fluorescent intensity of 10 repeats (24C-24D), as measured by Image J.

FIGS. 25A-25F includes micrographs showing that postharvest treatment with phenylalanine induces curing in potato tuber 14 days post-treatment. (25A-25D) Sifra potato; and (25E-25F) Memphis potato. (25A, 25C, and 25E) Control; and (25B, 25D, and 25F) Phe treated.

FIGS. 26A-26C include vertical bar graphs showing the effect of preharvest spray treatment on red coloration and TSS in Mango (Shelly) fruits. Red color surface (%; 26A), red color intensity (26B) and TSS (% Brix; 26C) were examined under preharvest treatments with 0.01%, 0.06%, 0.012%, or 0.24% phenylalanine (Phe). 0.01% (equivalent of ˜0.5 mM) Phe was found to be ineffective in improving red coloration, and was shown to be equivalent to negative control (26A-26B, rectangle frame). Preharvest treatment with 0.01% Phe had no contribution to TSS, such as negative control (26C).

FIGS. 27A-27D include vertical bar graphs showing the effect of preharvest spray treatment on red coloration and TSS in Apple (Starking Delicious) fruits. Red color surface (%; 27A), red color intensity (27B) and TSS (% Brix; 27C-27D) were examined under preharvest treatments with 0.01%, and 0.012% phenylalanine (Phe). 0.12% (equivalent of ˜6 mM) Phe was found to be substantially more effective in improving red coloration, and TSS compared to 0.01%, which was comparable to negative control. In 27D, TSS was evaluated at time 0 (TO), after cold storage (CS), and after time at shelf conditions (e.g., shelf-life (SL)).

FIG. 28 includes a vertical bar graph showing the effect of preharvest spray treatment on red coloration (represented as index 0-5) in grapes (Skarlota). 0.12% (equivalent of ˜6 mM) Phe was found to be substantially more effective in improving red color index compared to 0.01%.

FIGS. 29A-29E include micrographs showing the effect of preharvest treatment on decay parameters in Starking (29A-29B) and Anna (29C-29E) apples. In control fruits, enzymatic browning (i.e., oxidation) was highly evident (29A, and 29C). Treatment with 0.12% Phe, either 2 weeks preharvest (29B, and 29D) or 4 weeks preharvest (29E) were found to be effective in reducing enzymatic browning in apple fruits.

FIGS. 30A-30G include vertical bar graphs showing that a preharvest treatment of mango fruits with 8 mM phenylalanine increases the levels of aroma-associated VOCs. Mango (Tali) fruits were dipped in 8 mM phenylalanine and after 11 days of storage at 22° C. the profile of volatiles in the fruit float was examined. Concentration of the following volatile aroma substances was examined (presented as μg/gFW): (30A) α-Pinene; (30B) 3-Carene; (30C) D-Limonene; (30D) Gurjunene; (30E) α-Terpinolene; (30F) α-Phellandrene; and (30G) Caryophyllene.

FIGS. 31A-31C include a fluorescent micrograph (31A) and vertical bar graphs showing that postharvest treatment of Mango fruits (Tali and Shelly) with 8 mM phenylalanine reduces accumulation of reactive oxygen species (ROS) in the peel (31B) and pulp (31C) of treated injured fruits compared to control injured fruit (non-treated). The effect was observed for fruits stored in 12° C. as well as after shelf life (SL). (31A) Visualization conducted 20 minutes post induced injury. (31B-31C) ROS quantification 7 days post induced injury.

### DETAILED DESCRIPTION

The present invention, in some embodiments thereof, relates to a method for improving the quality of a plant material. In some embodiments, the plant material comprises a vegetable. In some embodiments, a vegetable comprises: a stalk, a leaf, a root tuber, a stem tuber, or any combination thereof. In some embodiments, the plant material comprises fruit. In some embodiments, the method comprises improving the quality of fruit parameters. In some embodiments, the present invention is directed to a method for improving the flavor of a plant material, e.g., fruit or juice extracted or derived therefrom. In some embodiments, the present invention is directed to a method for improving the quality of a plant material, e.g., fruit or juice extracted or derived therefrom. In some embodiments, the method comprises treating a plant material, e.g., fruit or a vegetable, with an effective amount of an aromatic amino acid or an analog thereof.

According to some aspects, the method of the invention is directed to shortening the growing and/or ripening period of plant material, as described herein. According to some aspects, the herein disclosed method enables shorter growing and/or ripening periods of a plant material, e.g., a vegetable, as described herein. According to some aspects, the herein disclosed method is directed to increasing the total harvested annual crop of a plant material, e.g., a vegetable, compared to a control. In some embodiments, a plant material, e.g., a vegetable treated according to the herein disclosed methods is suitable for harvest, e.g., quality, coloration, sweetness, phytochemicals content, or any combination thereof, within a shorter period of time, compared to a control. In some embodiments, a plant material, e.g., a vegetable treated according to the herein disclosed method is harvest earlier compared to a control plant material, e.g., a vegetable. In some embodiments, a plant material, e.g., a vegetable treated according to the herein disclosed method reaches suitable quality, coloration, sweetness, phytochemicals content, or any combination thereof, as described herein, earlier compared to a control e.g., fruit or a plant material, e.g., a vegetable.

According to another aspect, the herein disclosed method is directed to increasing the sweetness profile of a plant material, e.g., fruit or vegetable. In some embodiments, increasing the sweetness profile of a plant material comprises polysaccharides breakdown or catabolism. In some embodiments, increasing the sweetness profile of a plant material comprises reducing the amount of polysaccharides in the plant material. In some embodiments, according to the herein disclosed method, the amount of polysaccharides is reduced in a cell of the treated plant material, e.g., fruit, in the exocarp, epicarp, cortex, or any equivalent thereof, of the fruit, or any combination thereof. In some embodiments, according to the herein disclosed method, polysaccharides in the treated plant material are converted, broken down, metabolized, or any combination and equivalent thereof, to a monosaccharide, a disaccharide, or a combination thereof. In some embodiments, increasing the sweetness profile of a plant material comprises production of monosaccharides, disaccharides, or both, in the plant material. In some embodiments, the produced monosaccharides, disaccharides, or both, are obtained by the conversion, brake down, metabolism, or any combination and equivalent thereof, of polysaccharides.

In some embodiments, the polysaccharides comprises starch.

In some embodiments, the herein disclosed method comprises increasing the sweetness profile of a plant material while maintaining or preserving the nutritional value of the plant material. In some embodiments, the herein disclosed method comprises increasing the sweetness profile of a plant material while maintaining or preserving the caloric value, calorie index, or both, of the plant material.

In some embodiments, the herein disclosed method comprises increasing the sweetness profile of a plant material without increasing without reducing the nutritional value of the plant material. In some embodiments, the herein disclosed method comprises increasing the sweetness profile of a plant material without increasing the caloric value, calorie index, or both, of the plant material.

As used herein, the term “aromatic amino acid (AAA)”, refers to phenylalanine (Phe), Tyrosine (Tyr), Tryptophan (Trp), or any analog thereof. As used herein, any AAA analog is applicable as long as the analog maintains the anti-pathogenic and performance improving activities, as disclosed herein.

According to some embodiments, there is provided a method for improving flavor of a fruit comprising pre-harvest or post-harvest treatment contacting the plant material with an effective amount of phenylalanine or an analog thereof, thereby improving flavor of the plant material.

According to some embodiments, there is provided a method for reducing or inhibiting decay of a fruit, comprising pre-harvest or post-harvest treatment contacting the plant material with an effective amount of phenylalanine or an analog thereof, thereby reducing or inhibiting decay of a fruit.

In some embodiments, improving the quality of a plant material comprises reducing or inhibiting decay of the plant material. In some embodiments, the plant material comprises or consists of a fruit. In some embodiments, improving the quality of a plant material comprises reducing or inhibiting decay of a fruit.

In some embodiments, decay of a fruit comprises a decay of: cuticle, epidermis, parenchyma, hypodermis, pericarp, cortex, or any combination thereof.

In some embodiments, decay comprises enzymatic browning, e.g., oxidation.

In some embodiments, the method comprises reducing or inhibiting enzymatic browning of a fruit. In some embodiments, reduction or inhibition of enzymatic browning is determined in a sliced or cut-open fruit.

In some embodiments, reducing or inhibiting enzymatic browning of a fruit comprises reducing the rate, the volume, the surface area, or any combination thereof, of enzymatic browning in a fruit.

In some embodiments, treating comprises contacting, applying, or a combination thereof.

In some embodiments, the method comprises pre-harvest treatment, post-harvest treatment, or both.

In some embodiments, the method comprises at least once treating. Or contacting the plant material. In some embodiments, the method comprises at least 2 times, at least 3 times, at least 4 times, at least 5 times, at least 6 times, at least 8 times, or at least 10 times treating or contacting the plant material, or any value and range therebetween. Each possibility represents a separate embodiment of the invention. In some embodiments, method comprises 1-10 times, 2-10 times, 3-8 times, or 4-10 times treating or contacting the plant material. Each possibility represents a separate embodiment of the invention.

In some embodiments, the method comprises once or a least twice (e.g., multiple treating) treating or contacting the plant material.

In some embodiments, in multiple treating or contacting the plant material, each treating or contacting event is at least 5 days apart, at least 6 days apart, at least 7 days apart, at least 9 days apart, at least 10 days apart, at least 12 days apart, at least 15 days apart, at least 20 days apart, at least 25 days apart, at least 30 days apart, at least 40 days apart, or any value and range therebetween. Each possibility represents a separate embodiment of the invention. In some embodiments, in multiple treating or contacting the plant material, each treating or contacting event is 5-20 days apart, 7-21 days apart, 7-28 days apart, 7-35 days apart, 5-30 days apart, or 6-30 days apart. Each possibility represents a separate embodiment of the invention.

In some embodiments, treating a plant material with an aromatic amino acid or an analog thereof, comprises pre-harvest contacting a plant material with an aromatic amino acid or an analog thereof, post-harvest contacting a plant material with an aromatic amino acid or an analog thereof, or both.

In some embodiments, pre-harvest treatment comprises a plurality of pre-harvest treatments.

In some embodiments, post-harvesting contacting comprises a plurality of post-harvest contacting.

In some embodiments, the term “plurality” comprises any integer equal to or greater than 2.

In some embodiments, improving flavor comprises increasing the amount of anthocyanin, a flavonoid, or both, in the plant material or a juice extracted therefrom.

In some embodiments, improving flavor comprises increasing Brix value, reducing acidity value, increasing aroma, or both, in the fruit or a juice extracted therefrom.

In some embodiments, increasing aroma comprises increasing the amount of at least one volatile organic compound (VOC) associated or related to aroma.

Types of VOCs associated or related to fruit aroma, would be apparent to one of ordinary skill in the art, as well as methods of determining same.

In some embodiments, improving the fruit quality comprises increasing the amount of anthocyanin, flavonoid, or both, in said plant material or a juice extracted therefrom.

In some embodiments, improving the fruit quality comprises inducing red coloration, reducing the amount of chlorophyll, increasing the ratio of anthocyanin to chlorophyll, or any combination thereof, in the plant material.

In some embodiments, improving the fruit quality comprises increasing Brix value, reducing acidity value, increasing aroma, or both, in the fruit or a juice extracted therefrom.

In some embodiments, increasing fruit quality or flavor comprises increasing the amount, secreted level, or both, of at least one compound or VOC, being selected from: α-Pinene, 3-Carene, D-Limonene, Gurjunene, α-Terpinolene, α-Phellandrene, Caryophyllene, or any combination thereof.

In some embodiments, increasing fruit quality or flavor comprises increasing the amount, secreted level, or both, of α-Pinene, 3-Carene, D-Limonene, Gurjunene, α-Terpinolene, α-Phellandrene, and Caryophyllene.

In some embodiments, increasing is at least 5%, at least 20%, at least 50%, at least 75%, at least 100%, at least 250%, at least 500%, or at least 1,000% increase, or any value and range therebetween. Each possibility represents a separate embodiment of the invention.

In some embodiments, increasing is 5-200%, 20-300%, 50-400%, 75-500%, at least 100-1,200%, or 250-1,500% increase. Each possibility represents a separate embodiment of the invention.

In some embodiments, improving a fruit quality comprises reducing the rate, amount, or both, of reactive oxygen species (ROS) accumulation in the fruit. In some embodiments, improving the fruit quality comprises reducing the rate, amount, or both, of ROS accumulation in the peel of a fruit. In some embodiments, improving the fruit quality comprises reducing the rate, amount, or both, of ROS accumulation in the pulp of a fruit. In some embodiments, improving the fruit quality comprises reducing the rate, amount, or both, of ROS accumulation in the peel and the pulp of a fruit. In some embodiments, the method comprises reducing the rate, amount, or both, of ROS accumulation in the pulp, peel, or both, of an injured fruit. In some embodiments, the injured fruit is injured preharvest, postharvest, or both.

In some embodiments, improving fruit flavor comprises reducing the rate, amount, or both, of ROS accumulation in a fruit treated according to the herein disclosed method.

In some embodiments, improving fruit quality or parameter, comprises improving a fruit's firmness. In some embodiments, the method comprises increasing a fruit's firmness. In some embodiments, a fruit treated according to the method disclosed herein is firmer than a control untreated fruit.

Method for determining fruit's firmness are common and would be apparent to one of ordinary skill in the art.

In one embodiment, firmness is presented as Newton (N) units.

Methods for determining the amounts of anthocyanins, flavonoids, acidity, and Brix, are common and would be apparent to one of ordinary skill in the art. Non-limiting examples of such methods include, but are not limited to, pH test, GC-MS, chromometric examination, multiplexed fluorescence detection, or others, some of which are exemplified herein.

According to some embodiments, there is provided a method for improving coloration of a plant material comprising pre-harvest treatment with an effective amount of phenylalanine or an analog thereof, thereby improving coloration of the plant material.

In some embodiments, improving coloration comprises inducing red coloration and anthocyanins, reducing the amount of chlorophyll, increasing the ratio of anthocyanin to chlorophyll, or any combination thereof, in the plant material.

In some embodiments, improving coloration comprises increasing the surface area of the plant material manifesting red coloration. In some embodiments, improving coloration comprises reducing the surface area of the plant material manifesting green coloration. In some embodiments, improving coloration comprises increasing the ratio of the surface area of the plant material manifesting red coloration to the surface area of the plant material manifesting green coloration.

According to the method of the invention, in some embodiments, the duration of culturing of a fruit or a plant material as described herein, is shorter compared to a control fruit or a plant material (e.g., untreated according to the method of the invention). In some embodiments, fruit or a plant material treated according to the method of the invention, is harvested after a shorter period of culture, compared to a control fruit or a plant material (e.g., untreated according to the method of the invention). In some embodiments, the method of the invention, in some embodiments, provides at least one more harvest occasion annually per crop type, e.g., fruit or a plant material, compared to a control, as described herein.

In some embodiments, the method of the invention, in some embodiments, enables to shorten the period of culturing to harvest of fruit and/or plant material, increase the number of harvest occasions annually of a crop type, e.g., fruit or a plant material, or both, compared to a control, as described herein.

In some embodiments, the ratio comprises a molar to molar (m:m) ratio. In some embodiments, the ratio comprises a weight per weight (w/w) ratio.

In some embodiments, “increase” or “increasing” is at least 5%, at least 15%, at least 30%, at least 50%, at least 75%, at least 100%, at least 200%, at least 350%, at least 500%, at least 750%, or at least 1,000% increase, or any value and range therebetween. Each possibility represents a separate embodiment of the invention.

In some embodiments, “decrease” or “decreasing” is at least 5%, at least 15%, at least 30%, at least 50%, at least 75%, at least 100%, at least 200%, at least 350%, at least 500%, at least 750%, or at least 1,000% decrease, or any value and range therebetween. Each possibility represents a separate embodiment of the invention.

In some embodiments, the effective amount of phenylalanine or an analog thereof is at least 2 mM, at least 3 mM, at least 4 mM, at least 6 mM, at least 8 mM, at least 10 mM, at least 12 mM, at least 15 mM, at least 17 mM, or at least 20 mM, or any value and range therebetween. Each possibility represents a separate embodiment of the invention.

In some embodiments, the effective amount of phenylalanine or an analog thereof ranges from 2 mM to 20 mM, 4 mM to 20 mM, 6 mM to 20 mM, 8 mM to 20 mM, 10 mM to 20 mM, 12 mM to 20 mM, 4 mM to 8 mM, 4 mM to 10 mM, 4 mM to 12 mM, or 15 mM to 20 mM, or any value and range therebetween. Each possibility represents a separate embodiment of the invention.

In some embodiments, the method further comprises a step of providing a preharvest abiotic stress condition to the fruit.

In some embodiments, an abiotic stress condition is applied for a period of time ranging from 1 to 30 days, 2 to 30 days, 5 to 30 days, 7 to 30 days, 10 to 30 days, 14 to 30 days, 18 to 30 days, 23 to 30 days, 27 to 30 days, 1 to 20 days, 1 to 15 days, 5 to 30 days, 8 to 24 days, 10 to 20 days, or 7 to 21 days. Each possibility represents a separate embodiment of the invention.

In some embodiments, the abiotic stress condition comprises light, radiation, temperature, lack of nutrient, lack of water, or any combination thereof.

In some embodiments, the method further comprises a step of selecting a plant material in need of a treatment as disclosed herein.

In some embodiments, selecting comprises determining an amount of a phytochemical in a plant material compared to a predetermined threshold.

In some embodiments, selecting comprises determining the total soluble solids (TSS) % of a plant material. In some embodiments, selecting comprises determining the ratio of TTS to acid. In some embodiments, selecting comprises determining the TTS % or TTS/acid in a dry matter or wet matter of a plant material. In some embodiments, selecting comprises determining the TTS % or TTS/acid in a sample comprising dry matter or wet matter derived or extracted from a plant material.

In some embodiments, a fruit or a plant material, e.g., a vegetable, suitable for treatment according to the herein disclosed method is characterized by a TSS % or TSS/Acid or any equivalent standard thereof, being at least 5%, at least 10%, at least 15%, at least 25%, or at least 30%, lower than the TSS % or TSS/Acid or any equivalent standard thereof, known to one of ordinary skill in the art as the minimal TSS % or TSS/Acid or any equivalent standard thereof for harvesting the fruit or the plant material, or any value and range therebetween. Each possibility represents a separate embodiment of the invention.

In some embodiments, selecting comprises determining TSS % by weight or TSS/Acid in the fruit or a plant material, as described herein, compared to a control.

In some embodiments, a fruit or a plant material, e.g., a vegetable, comprising at least 5% less, at least 10% less, at least 15% less, at least 20% less, at least 25% less, or at least 30% less TSS % by weight or TSS/Acid compared to the control, is suitable for pre-harvest or post-harvest treatment with an effective amount of phenylalanine or an analog thereof.

In some embodiments, the term “control” encompasses a fruit, or a plant material characterized by TSS % by weight or TSS/Acid or any equivalent standard thereof, known to one of ordinary skill in the art as the minimal TSS % by weight or TSS/Acid or any equivalent standard thereof for harvesting.

In some embodiments, the method comprises providing a fruit and determining whether the fruit is characterized by a TSS % or TSS/Acid or any equivalent standard thereof, being at least 5%, at least 10%, at least 15%, at least 25%, or at least 30%, lower than the TSS % or TSS/Acid or any equivalent standard thereof, known to one of ordinary skill in the art as the minimal TSS % or TSS/Acid or any equivalent standard thereof for harvesting.

In some embodiments, the method comprises treatment determined as being characterized by a TSS % or TSS/Acid or any equivalent standard thereof, being at least 5%, at least 10%, at least 15%, at least 25%, or at least 30%, lower than the TSS % or TSS/Acid or any equivalent standard thereof, known to one of ordinary skill in the art as the minimal TSS % or TSS/Acid or any equivalent standard thereof, with an effective amount of an aromatic amino acid, e.g., phenylalanine.

In some embodiments, a fruit unsuitable for treatment according to the herein disclosed method is characterized by a TSS % or TSS/Acid or any equivalent standard thereof, being 4% lower at most, equal to, or greater than the TSS % or TSS/Acid or any equivalent standard thereof, known to one of ordinary skill in the art as the minimal TSS % or TSS/Acid or any equivalent standard thereof for harvesting the fruit, or any value and range therebetween. Each possibility represents a separate embodiment of the invention.

Table 1 herein below, brings a few examples of minimal threshold of soluble solids values indicating suitability of a fruit to be harvested.

| | Soluble Solids (%) | | Soluble Solids (%) |
|---|---|---|---|
| Apple (Honeycrisp) | 13 | Mangosteen | 17 |
| Apple, Granny Smith | 12 | Peach | 10 |
| Apricot | 10 | Nectarine | 10 |
| Asian Pear | 11 | Orange | 8 (TSS/Acid) |
| Avocado Fuerte | 19 (Dry Weight) | Papaya | 11.5 |
| Avocado Hass | 20.8 (Dry Weight) | Passion Fruit | 14 |
| Avocado Gwen | 24.2 (Dry Weight) | Pear | 10 |
| Banana | 12 | Persimmon | 18-21 |
| Cherry | 14 | Pineapple | 12 |
| Date | 50 | Plum | 10 |
| Grapes, White Wine | 18 | Pomegranate | 17 |
| Grapes, Red Wine | 21 | Rambutan | 16 |
| Grapefruit | 5.5-6 (TSS/Acid) | Sapotes | 13 |
| Kiwifruit | 14 | Strawberry | 7 |
| Lychee | 30 (TSS/Acid) | Tamarillo | 10 |
| Mandarin | 6.5 (TSS/Acid) | Tomato | 12 |
| Mango | 7-8 | Watermelon | 10 |

In some embodiments, an apple fruit suitable for treatment according to the herein disclosed method is characterized by a TSS % value of 10 at most, TSS % value of 11 at most, or TSS % value of 12 at most, or any value and range therebetween. Each possibility represents a separate embodiment of the invention. In some embodiments, an apple fruit suitable for treatment according to the herein disclosed method is characterized by a TSS % value lower than 12 or 13.

In some embodiments, an apricot fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, an apricot fruit suitable for treatment according to the herein disclosed method is characterized by a TSS % value lower than 10.

In some embodiments, an Asian pear fruit suitable for treatment according to the herein disclosed method is characterized by a TSS % value of 7 at most, TSS % value of 8 at most, TSS % value of 9 at most, or TSS % value of 10 at most, or any value and range therebetween. Each possibility represents a separate embodiment of the invention. In some embodiments, an Asian pear fruit suitable for treatment according to the herein disclosed method is characterized by a TSS % value lower than 11.

In some embodiments, an avocado fruit suitable for treatment according to the herein disclosed method is characterized by a TSS % value of 20 at most by dry weight, TSS % value of 21 at most by dry weight, TSS % value of 22 at most by dry weight, TSS % value of 23 at most by dry weight, TSS % value of 24 at most by dry weight, or TSS % value of 25 at most by dry weight, or any value and range therebetween. Each possibility represents a separate embodiment of the invention. In some embodiments, an avocado fruit suitable for treatment according to the herein disclosed method is characterized by a TSS % value lower than 24.5 by dry weight.

In some embodiments, a banana fruit suitable for treatment according to the herein disclosed method is characterized by a TSS % value of 8 at most, TSS % value of 9 at most, TSS % value of 10 at most, or TSS % value of 11 at most, or any value and range therebetween. Each possibility represents a separate embodiment of the invention. In some embodiments, a banana fruit suitable for treatment according to the herein disclosed method is characterized by a TSS % value lower than 12.

In some embodiments, a cherry fruit suitable for treatment according to the herein disclosed method is characterized by a TSS % value of 10 at most, TSS % value of 11 at most, TSS % value of 12 at most, or TSS % value of 13 at most, or any value and range therebetween. Each possibility represents a separate embodiment of the invention. In some embodiments, a cherry fruit suitable for treatment according to the herein disclosed method is characterized by a TSS % value lower than 14.

In some embodiments, a date fruit suitable for treatment according to the herein disclosed method is characterized by a TSS % value of 35 at most, TSS % value of 40 at most, TSS % value of 45 at most, or TSS % value of 49 at most, or any value and range therebetween. Each possibility represents a separate embodiment of the invention. In some embodiments, a date fruit suitable for treatment according to the herein disclosed method is characterized by a TSS % value lower than 50.

In some embodiments, grapes suitable for treatment according to the herein disclosed method are characterized by a TSS % value of 17 at most, TSS % value of 18 at most, TSS % value of 19 at most, or TSS % value of 20 at most, or any value and range therebetween. Each possibility represents a separate embodiment of the invention. In some embodiments, grapes suitable for treatment according to the herein disclosed method are characterized by a TSS % value lower than 18-21.

In some embodiments, a grapefruit suitable for treatment according to the herein disclosed method is characterized by a TSS/Acid value of 2 at most, TSS/Acid value of 3 at most, TSS/Acid value of 4 at most, or TSS/Acid value of 5 at most, or any value and range therebetween. Each possibility represents a separate embodiment of the invention. In some embodiments, a grapefruit suitable for treatment according to the herein disclosed method is characterized by a TSS/Acid value lower than 5.5-6.

In some embodiments, a kiwifruit suitable for treatment according to the herein disclosed method is characterized by a TSS % value of 10 at most, TSS % value of 11 at most, TSS % value of 12 at most, or TSS % value of 13 at most, or any value and range therebetween. Each possibility represents a separate embodiment of the invention. In some embodiments, a kiwifruit suitable for treatment according to the herein disclosed method is characterized by a TSS % value lower than 14.

In some embodiments, a lychee fruit suitable for treatment according to the herein disclosed method is characterized by a TSS/Acid value of 26 at most, TSS/Acid value of 27 at most, TSS/Acid value of 28 at most, or TSS/Acid value of 29 at most, or any value and range therebetween. Each possibility represents a separate embodiment of the invention. In some embodiments, a lychee fruit suitable for treatment according to the herein disclosed method is characterized by a TSS/Acid value lower than 30.

In some embodiments, a mandarin fruit suitable for treatment according to the herein disclosed method is characterized by a TSS/Acid value of 3 at most, TSS/Acid value of 4 at most, TSS/Acid value of 5 at most, or TSS/Acid value of 6 at most, or any value and range therebetween. Each possibility represents a separate embodiment of the invention. In some embodiments, a mandarin fruit suitable for treatment according to the herein disclosed method is characterized by a TSS/Acid value lower than 6.5.

In some embodiments, a mango fruit suitable for treatment according to the herein disclosed method is characterized by a TSS % value of 5 at most, TSS % value of 6 at most, TSS % value of 7 at most, or TSS % value of 8 at most, or any value and range therebetween. Each possibility represents a separate embodiment of the invention. In some embodiments, a mango fruit suitable for treatment according to the herein disclosed method is characterized by a TSS % value lower than 7-8.

In some embodiments, a mangosteen fruit suitable for treatment according to the herein disclosed method is characterized by a TSS % value of 14 at most, TSS % value of 15 at most, TSS % value of 16 at most, or TSS % value of 8 at most, or any value and range therebetween. Each possibility represents a separate embodiment of the invention. In some embodiments, a mangosteen fruit suitable for treatment according to the herein disclosed method is characterized by a TSS % value lower than 17.

In some embodiments, a peach fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, a mango suitable for treatment according to the herein disclosed method is characterized by a TSS % value lower than 10.

In some embodiments, a nectarine fruit suitable for treatment according to the herein disclosed method is characterized by a TSS % value of 7 at most, TSS % value of 8 at most, TSS % value of 9 at most, or TSS % value of 8 at most, or any value and range therebetween. Each possibility represents a separate embodiment of the invention. In some embodiments, a nectarine suitable for treatment according to the herein disclosed method is characterized by a TSS % value lower than 10.

In some embodiments, an orange fruit suitable for treatment according to the herein disclosed method is characterized by a TSS/Acid value of 4 at most, TSS/Acid value of 5 at most, TSS/Acid value of 6 at most, or TSS/Acid value of 7 at most, or any value and range therebetween. Each possibility represents a separate embodiment of the invention. In some embodiments, an orange fruit suitable for treatment according to the herein disclosed method is characterized by a TSS/Acid value lower than 8.

In some embodiments, a papaya fruit suitable for treatment according to the herein disclosed method is characterized by a TSS % value of 8 at most, TSS % value of 9 at most, TSS % value of 10 at most, or TSS % value of 11 at most, or any value and range therebetween. Each possibility represents a separate embodiment of the invention. In some embodiments, a papaya fruit suitable for treatment according to the herein disclosed method is characterized by a TSS % value lower than 11.5.

In some embodiments, a passionfruit suitable for treatment according to the herein disclosed method is characterized by a TSS % value of 10 at most, TSS % value of 11 at most, TSS % value of 12 at most, or TSS % value of 13 at most, or any value and range therebetween. Each possibility represents a separate embodiment of the invention. In some embodiments, a passionfruit suitable for treatment according to the herein disclosed method is characterized by a TSS % value lower than 14.

In some embodiments, a pear fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, a pear fruit suitable for treatment according to the herein disclosed method is characterized by a TSS % value lower than 10.

In some embodiments, a persimmon fruit suitable for treatment according to the herein disclosed method is characterized by a TSS % value of 15 at most, TSS % value of 16 at most, TSS % value of 17 at most, TSS % value of 18 at most, TSS % value of 19 at most, or TSS % value of 20 at most, or any value and range therebetween. Each possibility represents a separate embodiment of the invention. In some embodiments, a persimmon fruit suitable for treatment according to the herein disclosed method is characterized by a TSS % value lower than 18-21.

In some embodiments, a pineapple fruit suitable for treatment according to the herein disclosed method is characterized by a TSS % value of 8 at most, TSS % value of 9 at most, TSS % value of 10 at most, or TSS % value of 11 at most, or any value and range therebetween. Each possibility represents a separate embodiment of the invention. In some embodiments, a pineapple fruit suitable for treatment according to the herein disclosed method is characterized by a TSS % value lower than 12.

In some embodiments, a plum fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, a plum fruit suitable for treatment according to the herein disclosed method is characterized by a TSS % value lower than 10.

In some embodiments, a pomegranate fruit suitable for treatment according to the herein disclosed method is characterized by a TSS % value of 13 at most, TSS % value of 14 at most, TSS % value of 15 at most, or TSS % value of 16 at most, or any value and range therebetween. Each possibility represents a separate embodiment of the invention. In some embodiments, a pomegranate fruit suitable for treatment according to the herein disclosed method is characterized by a TSS % value lower than 17.

In some embodiments, a rambutan fruit suitable for treatment according to the herein disclosed method is characterized by a TSS % value of 12 at most, TSS % value of 13 at most, TSS % value of 14 at most, or TSS % value of 15 at most, or any value and range therebetween. Each possibility represents a separate embodiment of the invention. In some embodiments, a rambutan fruit suitable for treatment according to the herein disclosed method is characterized by a TSS % value lower than 16.

In some embodiments, a sapota fruit suitable for treatment according to the herein disclosed method is characterized by a TSS % value of 9 at most, TSS % value of 10 at most, TSS % value of 11 at most, or TSS % value of 12 at most, or any value and range therebetween. Each possibility represents a separate embodiment of the invention. In some embodiments, a sapota fruit suitable for treatment according to the herein disclosed method is characterized by a TSS % value lower than 13.

In some embodiments, a strawberry fruit suitable for treatment according to the herein disclosed method is characterized by a TSS % value of 3 at most, TSS % value of 4 at most, TSS % value of 5 at most, or TSS % value of 6 at most, or any value and range therebetween. Each possibility represents a separate embodiment of the invention. In some embodiments, a strawberry fruit suitable for treatment according to the herein disclosed method is characterized by a TSS % value lower than 7.

In some embodiments, a tamarillo fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, a tamarillo fruit suitable for treatment according to the herein disclosed method is characterized by a TSS % value lower than 10.

In some embodiments, a watermelon fruit suitable for treatment according to the herein disclosed method is characterized by a TSS % value of 6 at most, TSS % value of 7 at most, TSS % value of 8 at most, or TSS % value of 9 at most, or any value and range therebetween. Each possibility represents a separate embodiment of the invention. In some embodiments, a watermelon fruit suitable for treatment according to the herein disclosed method is characterized by a TSS % value lower than 10.

In some embodiments, a plant material, such as fruit, comprising the phytochemical in an amount greater than the predetermined threshold is suitable for pre-harvest, post-harvest, or both, treatment with an effective amount of phenylalanine or an analog thereof.

In some embodiments, a plant material, such as fruit, comprising the phytochemical in an amount lower than the predetermined threshold is unsuitable for pre-harvest, post-harvest, or both, treatment with an effective amount of phenylalanine or an analog thereof.

In some embodiments, a plant material, such as fruit, comprising the phytochemical in an amount lower than the predetermined threshold is suitable for pre-harvest, post-harvest, or both, treatment with an effective amount of phenylalanine or an analog thereof.

In some embodiments, a plant material, such as fruit, comprising the phytochemical in an amount greater than the predetermined threshold is unsuitable for pre-harvest, post-harvest, or both, treatment with an effective amount of phenylalanine or an analog thereof.

In some embodiments, “lower” or “greater” is by at least 5% lower or greater compared to the predetermined threshold.

In some embodiments, the phytochemical is selected from: a flavonoid, an anthocyanin, a pigment, or any combination thereof.

In some embodiments, a pigment comprises chlorophyll.

In some embodiments, treatment comprises drenching, dipping, soaking, injecting, spraying, coating, or any combination thereof.

In some embodiments, treatment is in an open field, a greenhouse, a storage facility, or any combination thereof.

In some embodiments, improving is compared to a control plant material, e.g., fruit or vegetable, or a plant comprising same. In some embodiments, a control comprises a control tuber or a plant comprising same.

In some embodiments, an AAA, for example, Phe, as utilized herein improves flavor, coloration, or both, in a fruit, or juice extracted or derived therefrom.

In some embodiments, there is provided a composition comprising AAA for use in improving flavor, coloration, quality parameters, or a combination thereof, of a fruit or juice extracted or derived therefrom.

In one embodiment, a composition comprising AAA is used for improving flavor, coloration, quality parameters, or a combination thereof, of a plant material, such as fruit, or juice extracted or derived therefrom, wherein a concentration of AAA, such as phenylalanine or an analog thereof, is 2 mM to 20 mM. In one embodiment, a concentration of AAA, such as phenylalanine, of 2 mM to 20 mM, is used for improving flavor, coloration, quality parameters, or a combination thereof, of a plant material, such as fruit, or juice extracted or derived therefrom.

As used herein, the term “juice” encompasses any portion or fraction of juice extracted or derived from a fruit, as disclosed herein.

In some embodiments, the term “weight” refers to dry weight. In other embodiments, weight refers to wet weight.

According to some embodiments of the invention, the plant is a dicotyledonous plant. According to some embodiments of the invention, the plant is a monocotyledonous plant.

According to an embodiment, the fruit is a fruit of a cultivated fruit plant. According to an embodiment, the cultivated fruit plant refers to a plant in which fruits are of an economic value. According to an embodiment, the cultivated fruit plant is selected from apple, apricot, Asian pear, avocado, Banana, bell-pepper, chili-pepper, cherry, corn, cucumber, date, eggplant, grapes, grapefruit, kiwi fruit, lychee, mandarin, mango, mangosteen, melon, pumpkin, peach, pears, nectarine, orange, papaya, passion fruit, pear, persimmon, pineapple, plum, pomegranate, rambutan, sapotes, strawberry, tamarillo, tomato, watermelon, lemon.

In one embodiment, the cultivated fruit plant comprises any citrus fruit.

According to some embodiments, there is provided a method for improving a plant material quality.

In some embodiments, improving the quality of a plant material comprises increasing scratch curing, increasing cut curing, increasing scratch color curing, reducing weight loss %, increasing lignin production rate or suberin production rate or both, or any combination thereof, of the plant material.

According to some embodiments, there is provided a method for improving the curing of a tuber to damage.

In some embodiments, the method comprises pre-harvest, post-harvest, or both, treating a tuber, foliage of a plant comprising the tuber, or both, with an effective amount of phenylalanine or an analog thereof, thereby improving the curing of a tuber to the damage.

In some embodiments, the damage is induced by a biotic agent, an abiotic agent, or both. In some embodiments, the damage is biotic damage. In some embodiments, the damage is an abiotic damage (such as, but not limited to a physical or a mechanical injury).

In some embodiments, a biotic agent comprises a plant pathogen or a pest.

In some embodiments, the plant pathogen or a pest comprises: a virus, a bacterium, a nematode, an arthropod or any developmental stage thereof, or any combination thereof.

In some embodiments, an arthropod comprises or is an insect.

In some embodiments, an abiotic agent comprises a physical or a mechanical injury.

In some embodiments, improving the curing comprises: increasing scratch curing, increasing cut curing, increasing scratch color curing, reducing weight loss %, increasing lignin or suberin production rate, or any combination thereof.

In some embodiments, the tuber comprises a stem tuber or a root tuber.

In some embodiments, the tuber is a stem tuber. In some embodiments, the tuber is a root tuber.

Types of tubers would be apparent to one of ordinary skill in the art.

In some embodiments, the tuber is selected from: a potato, a sweet potato (e.g., yam), cassava, carrot, radish, Jicama, or any combination thereof.

In some embodiments, the tuber is a potato tuber.

As used herein, the term “tuber” encompasses a plant comprising a tuber. In some embodiments, a tuber is a potato plant.

As used herein the term, “Phenylalanine” or “Phe” refers to the α-amino acid with the formula C9H11NO2. It can be viewed as a benzyl group substituted for the methyl group of alanine, or a phenyl group in place of a terminal hydrogen of alanine. This essential amino acid is classified as neutral, and nonpolar because of the inert and hydrophobic nature of the benzyl side chain. The L-isomer is used to biochemically form proteins, coded for by DNA. The codons for L-phenylalanine are UUC and UUU. Phenylalanine is a precursor for tyrosine; the monoamine neurotransmitters dopamine, norepinephrine (noradrenaline), and epinephrine (adrenaline); and the skin pigment melanin.

As used herein the term, “Tyrosine” or “Tyr” refers to the an amino acid with the formula C9H11NO3. It can be viewed as a tyrosyl group substituted for the methyl group of alanine. This non-essential amino acid is classified as neutral, and nonpolar because of the inert and hydrophobic nature of the tyrosyl side chain. The L-isomer is used to biochemically form proteins, coded for by DNA. The codons for L-tyrosine are UAC and UAU.

As used herein the term, “Tryptophan” or “Trp” refers to the α-amino acid with the formula C11H12N2O2. This essential amino acid is classified as neutral, and nonpolar because of the inert and hydrophobic nature of the benzyl side chain. The L-isomer is used to biochemically form proteins, coded for by DNA. The codon for Tryptophan is UGG. Tryptophan is a precursor for the neurotransmitter serotonin, the hormone melatonin, and vitamin B3.

An “analog of Phenylalanine” or “an analog of Phe” refers to any naturally occurring or synthetically produced (chemically synthesized or biologically synthesized) analog of Phe, as long as it is capable of improving fruit flavor, coloration, quality parameters, or any combination thereof, as disclosed herein.

According to an embodiment, the Phe analog is a naturally occurring compound. In one embodiment, the use of the term “Phe” includes a composition comprising an effective amount of Phe or an analog thereof. According to some embodiments, the Phe analog comprises or is an aromatic compound. According to an embodiment, the Phe analog is Tyrosine or a synthetic analog thereof which is capable of improving fruit flavor, coloration, quality parameters, or any combination thereof, as disclosed herein. Synthetic analogs are commercially available such as from AnaSpec. A non-limiting example list is provided infra. Measures are taken to test for Phyto-toxicity before applying onto the plant. Table 2 below lists some non-limiting examples of Phe and Tyr analogs.

TABLE 2
Phe and Tyr analogs
(2R, 3R)-Boc-β-methyl-phenylalanine
(2R, 3R)-Boc-β-methyl-phenylalanine
(2R, 3R)/(2S, 3S)-Racemic-Boc-β-methyl-phenylalanine
(2R, 3S)/(2S, 3R)-Racemic Boc-β-hydroxyphenylalanine
(2R, 3S)/(2S, 3R)-Racemic Boc-β-hydroxyphenylalanine
(2R, 3S)/(2S, 3R)-Racemic Fmoc-β-hydroxyphenylalanine
(2R, 3S)/(2S, 3R)-Racemic Fmoc-β-hydroxyphenylalanine
(2S, 3S)-Boc-β-methyl-phenylalanine
(2S, 3S)-Boc-β-methyl-phenylalanine
Boc-a-methyl-3-methoxy-DL-phenylalanine
Boc-a-methyl-3-methoxy-DL-phenylalanine
Boc-a-methyl-D-phenylalanine
Boc-a-methyl-L-phenylalanine
Boc-a-methyl-L-phenylalanine
Boc-β-methyl-DL-phenylalanine
Boc-β-methyl-DL-phenylalanine
Boc-(R)-1,2,3,4-tetrahydroisoquino-line-3-carboxylic acid
Boc-D-Tic-OH
Boc-(R)-1,2,3,4-tetrahydroisoquino-line-3-carboxylic acid
Boc-D-Tic-OH
Boc-(S)-1,2,3,4-tetrahydroisoquinoline-line-3-carboxylic acid
Boc-L-Tic-OH
Boc-(S)-1,2,3,4-tetrahydroisoquinoline-line-3-carboxylic acid
Boc-L-Tic-OH
Boc-2,4-dichloro-D-phenylalanine
Boc-2,4-dichloro-L-phenylalanine
Boc-2-(trifluoromethyl)-D-phenylalanine
Boc-2-(trifluoromethyl)-L-phenylalanine
Boc-2-bromo-D-phenylalanine
Boc-2-bromo-L-phenylalanine
Boc-2-bromo-L-phenylalanine
Boc-2-chloro-D-phenylalanine
Boc-2-chloro-L-phenylalanine
Boc-2-cyano-D-phenylalanine
Boc-2-cyano-L-phenylalanine
Boc-2-cyano-L-phenylalanine
Boc-2-fluoro-D-phenylalanine
Boc-2-fluoro-L-phenylalanine
Boc-2-methyl-D-phenylalanine
Boc-2-methyl-L-phenylalanine
Boc-2-nitro-D-phenylalanine
Boc-2-nitro-L-phenylalanine
Boc-2;4;5-trihydroxy-DL-phenylalanine
Boc-3,4,5-trifluoro-D-phenylalanine
Boc-3,4,5-trifluoro-L-phenylalanine
Boc-3,4-dichloro-D-phenylalanine
Boc-3,4-dichloro-L-phenylalanine
Boc-3,4-difluoro-D-phenylalanine
Boc-3,4-difluoro-L-phenylalanine
Boc-3,4-dihydroxy-L-phenylalanine
Boc-3,4-dihydroxy-L-phenylalanine
Boc-3,4-dimethoxy-L-phenylalanine
Boc-3,5,3'-triiodo-L-thyronine
Boc-3,5-diiodo-D-tyrosine
Boc-3,5-diiodo-L-thyronine
Boc-3,5-diiodo-L-tyrosine
Boc-3-(trifluoromethyl)-D-phenylalanine
Boc-3-(trifluoromethyl)-L-phenylalanine
Boc-3-amino-L-tyrosine
Boc-3-amino-L-tyrosine
Boc-3-bromo-D-phenylalanine
Boc-3-bromo-L-phenylalanine
Boc-3-chloro-D-phenylalanine
Boc-3-chloro-D-phenylalanine
Boc-3-chloro-L-phenylalanine
Boc-3-chloro-L-phenylalanine
Boc-3-chloro-L-tyrosine
Boc-3-cyano-D-phenylalanine
Boc-3-cyano-L-phenylalanine
Boc-3-cyano-L-phenylalanine
Boc-3-fluoro-D-phenylalanine
Boc-3-fluoro-DL-tyrosine
Boc-3-fluoro-DL-tyrosine
Boc-3-fluoro-L-phenylalanine
Boc-3-iodo-D-phenylalanine
Boc-D-Phe(3-I)-OH
Boc-3-iodo-L-phenylalanine
Boc-Phe(3-I)-OH
Boc-3-iodo-L-phenylalanine
Boc-Phe(3-I)-OH
Boc-3-iodo-L-tyrosine
Boc-3-iodo-L-tyrosine
Boc-3-methyl-D-phenylalanine
Boc-3-methyl-L-phenylalanine
Boc-3-nitro-D-phenylalanine
Boc-3-nitro-L-phenylalanine
Boc-3-nitro-L-tyrosine
Boc-3-nitro-L-tyrosine
Boc-4-(Fmoc-aminomethyl)-D-phenylalanine
Boc-4-(Fmoc-aminomethyl)-L-phenylalanine
Boc-4-(trifluoromethyl)-D-phenylalanine
Boc-4-(trifluoromethyl)-L-phenylalanine
Boc-4-amino-D-phenylalanine
Boc-4-amino-D-phenylalanine
Boc-4-amino-L-phenylalanine
Boc-4-amino-L-phenylalanine
Boc-4-benzoyl-D-phenylalanine
Boc-D-Bpa-OH
Boc-4-benzoyl-L-phenylalanine
Boc-L-Bpa-OH
Boc-4-benzoyl-L-phenylalanine
Boc-L-Bpa-OH
Boc-4-bis(2-chloroethyl)amino-L-phenylalanine
Boc-4-bromo-D-phenylalanine
Boc-4-bromo-D-phenylalanine
Boc-4-bromo-L-phenylalanine
Boc-4-bromo-L-phenylalanine
Boc-4-chloro-D-phenylalanine
Boc-4-chloro-L-phenylalanine
Boc-4-chloro-L-phenylalanine
Boc-4-cyano-D-phenylalanine
Boc-4-cyano-L-phenylalanine
Boc-4-cyano-L-phenylalanine
Boc-4-fluoro-D-phenylalanine
Boc-4-fluoro-L-phenylalanine
Boc-4-fluoro-L-phenylalanine
Boc-4-iodo-D-phenylalanine
Boc-4-iodo-L-phenylalanine
Boc-4-iodo-L-phenylalanine
Boc-4-methyl-D-phenylalanine
Boc-4-methyl-L-phenylalanine
Boc-4-nitro-D-phenylalanine
Boc-4-nitro-L-phenylalanine
Boc-5-bromo-2-methoxy-D-phenylalanine
Boc-5-bromo-2-methoxy-L-phenylalanine
Boc-7-hydroxy-(R)-1,2,3,4-tetrahydroisoquinoline-3-carboxylic acid
Boc-hydroxy-D-Tic-OH
Boc-7-hydroxy-(R)-1,2,3,4-tetrahydroisoquinoline-3-carboxylic acid
Boc-hydroxy-D-Tic-OH
Boc-7-hydroxy-(S)-1,2,3,4-tetrahydroisoquinoline-3-carboxylic acid
Boc-hydroxy-Tic-OH
Boc-7-hydroxy-(S)-1,2,3,4-tetrahydroisoquinoline-3-carboxylic acid
Boc-hydroxy-Tic-OH
Boc-D-3,3-diphenylalanine
Boc-D-homophenylalanine
Boc-D-homophenylalanine
Boc-D-pentafluorophenylalanine

TABLE 3

Non-limiting examples of Trp analogs
Boc-4-methyl-DL-tryptophan
Boc-6-fluoro-DL-tryptophan
Boc-6-methyl-DL-tryptophan
Boc-DL-7-azatryptophan
Fmoc-(R)-7-azatryptophan
Fmoc-5-benzyloxy-DL-tryptophan
Fmoc-5-bromo-DL-tryptophan
Fmoc-5-chloro-DL-tryptophan
Fmoc-5-hydroxy-L-tryptophan
Fmoc-6-chloro-L-tryptophan
Fmoc-6-methyl-DL-tryptophan
Fmoc-7-methyl-DL-tryptophan
Fmoc-DL-7-azatryptophan

According to an embodiment, the analog is Aspartame. According to an embodiment, the analog is Tyrosine.

It may be possible to use low concentration (e.g., 0.01-10 mM, 0.01-5 mM, 0.01-1 mM, 0.1-10 mM, 0.1-5 mM, 0.1-1 mM) of AAA, such as Phe, Tyr, Trp, or analogs thereof, especially when used in conjunction with a surfactant or when combinations of AAA and analogs are used (e.g., Phe, Tyr, and Trp).

According to an embodiment, the AAA, such as Phe or analog thereof is administered at a concentration that does not cause sedimentation on the plant. According to an embodiment, the Phe or analog thereof is administered at a concentration that does not cause Phe sedimentation on the plant.

In some embodiments, the AAA, such as Phe or analog thereof is administered at a concentration that does not cause or induces ripening and/or decay of a fruit.

As used herein “plant” refers to whole plants, a plant tissue, a plant organ, a fruit, a vegetable, an eatable portion of a plant, a grafted plant including seeds, shoots, stems, roots (including tubers), rootstock, scion, and plant cells, tissues, fruit, flower and organs. The plant may be in any form including cuttings and harvested material (e.g., fruit).

The Phe (or analog) can be applied to a fruit by spraying, dusting, coating, soaking, irrigation, drenching or otherwise treating it with the active ingredients.

When indicated a specific stage, the application can be confined only to this stage or to the recited stage and additionally to another stage. For instance, when indicated applying at blossom, applying can be performed at blossom or blossom+post-blossom (i.e., fruit), or pre-blossom and blossom or pre-blossom and blossom and post blossom.

According to an embodiment, the phenylalanine or analog is formulated in a composition selected from a dip, a spray or a concentrate. According to an embodiment, applying is in the vicinity of or onto the fruits of the plant. According to an embodiment, applying is by irrigation, drenching, dipping, soaking, injection, coating or spraying. According to an embodiment, applying is in an open field. According to an embodiment, applying is in a greenhouse. According to an embodiment, applying is in a storage facility (e.g., dark room, refrigerator). According to an embodiment, applying is applying once. According to an embodiment, applying is applying at least twice at any regimen or duration as necessary and/or as described herein.

According to an embodiment, applying comprises repeated application (2 or more applications e.g., every week, seasonal, bi-weekly, bi-monthly etc.). Repeated applications are especially envisaged for field/greenhouse treatments.

According to an embodiment, repeated application comprises weekly, daily, monthly, or bi-monthly administration during blossom, post-blossom, pre-blossom, or any combination thereof. For example, suggested regimen may include but is not limited to, spraying plants in open fields and green house, adding to irrigation of plants grown in the open field, green house and in pots, dipping the whole foliage branch in the solution post-harvest, adding to vase of cut flowers before and/or after harvest and possibly before shipment.

According to an embodiment, the active ingredient (Phe and/or analog) is formulated into a composition where it is mixed with other active ingredients (e.g., fungicides) and/or an agriculturally acceptable carrier.

According to an embodiment such a composition of the invention is shelf stable. The term “shelf stable” refers to a composition of the invention that maintains its activity throughout a given storage period at the recommended conditions (e.g., temperature) and optionally does not separate out into separate phases or develop any offensive odors.

As used herein the term “agriculturally acceptable carrier” refers to a material that facilitates application of a composition of the invention to the intended target, which may be for example a plant, a plant material, compost, earth, surroundings or equipment, or that facilitates storage, transport or handling. Carriers used in compositions for application to plants and plant material are preferably non-phytotoxic or only mildly phytotoxic. A suitable carrier may be a solid, liquid or gas depending on the desired formulation. In one embodiment the carriers include polar liquid carriers such as water, mineral oils and vegetable oils. In one embodiment the carrier enhances the stability of the active ingredient as described herein.

Examples of liquid carriers include but are not limited to water; alcohols, particularly butanol or glycol, as well as their ethers or esters, particularly methylglycol acetate; ketones, particularly acetone, cyclohexanone, methylethyl ketone, methylisobutylketone, or isophorone; petroleum fractions such as paraffinic or aromatic hydrocarbons, particularly xylenes or alkyl naphthalenes; mineral or vegetable oils; aliphatic chlorinated hydrocarbons, particularly trichloroethane or methylene chloride; aromatic chlorinated hydrocarbons, particularly chlorobenzenes; water-soluble or strongly polar solvents such as dimethylformamide, dimethyl sulfoxide, or N-methylpyrrolidone; liquefied gases; or the like or a mixture thereof.

Examples of solid carriers include but are not limited to fillers such as kaolin, bentonite, dolomite, calcium carbonate, talc, powdered magnesia, Fuller's earth, gypsum, diatomaceous earth, and China clay. A carrier which provides for slow or delayed release of a compound (Phe or analog) of the invention may also be included in a composition of the invention (especially for the short life cycle pathogens).

In another embodiment, a composition (or active ingredient thereof—Phe or analog) of the invention is applied in an amount capable of inhibiting germination of bacterial spores or bacterial spreading. According to an embodiment, the composition (or active ingredient thereof—Phe or analog) of the invention is applied in an amount capable of reducing the standard concentration advised by a regulatory agency (e.g., FDA, USDA) of commonly used agrotech formulations.

Applying may be directly to the fruit, plant or to a surface in sufficient vicinity to the fruit or plant to improve flavor, coloration or parameters as described herein. In one embodiment, vicinity is within a distance of about 1 meter. In one embodiment, vicinity is within a distance of about 0.7 meter. In one embodiment, vicinity is within a distance of about 0.5 meter. In one embodiment, vicinity is within a distance of about 0.2 meter.

Thus, applying can be to any target surface of a plant or a plant organ, e.g., a fruit, to which a compound or composition of the invention may be applied, for example to a plant, plant material including fruit, roots, bulbs, fruit, tubers, corms, leaves, flowers, seeds, stems, callus tissue, nuts, grains, cuttings, root stock, scions, harvested crops including roots, bulbs, tubers, corms, leaves, flowers, seeds, stems, callus tissue, nuts, grains, fruit, cuttings, root stock, scions, or any surface that may contact harvested crops including harvesting equipment, packaging equipment and packaging material.

For surfaces such as harvesting equipment, packaging equipment and packaging material, the compound or composition of the invention is applied before use of the harvesting equipment, packaging equipment or packaging material.

According to an embodiment, the compound or composition of the invention is formulated as a dip, a powder, a spray or a concentrate. According to an embodiment, the formulation comprises a surfactant. According to an embodiment, the surfactant is a cationic surfactant, e.g., benzalkonium chloride, cetylpyridinium chloride. According to an embodiment, the surfactant is an anionic surfactant, e.g., alkyl sulphates, alkyl ethoxylate sulphates. According to an embodiment, the surfactant is a non-ionic surfactant, e.g., Alkyl polyglycoside, Triton X-100, Polyoxyethylene (20) sorbitan monooleate (Tween-80), Silwett L-77. According to an embodiment, the surfactant is Tween-80 or Silwett L-77.

According to an embodiment, the concentration of the surfactant is at least 0.1%. In one embodiment, a composition of the invention may further comprise at least one additional agricultural agent. In an alternative embodiment a composition of the invention may be delivered separately, simultaneously, or sequentially with at least one additional agricultural agent.

In some embodiments, the AAA can be in a composition with a coating agent, such as but not limited to, a polysaccharide.

According to an embodiment the agricultural composition may comprise phenylalanine and tyrosine for improving fruit flavor (including juice extracted or derived therefrom), coloration, quality parameters, or any combination thereof.

As used herein the term “about” refers to ±10%.

The terms “comprises”, “comprising”, “includes”, “including”, “having” and their conjugates mean “including but not limited to”.

The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure. As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### EXAMPLES

Reference is now made to the following examples, which together with the above descriptions illustrate some embodiments of the invention in a non-limiting fashion.

### Example 1

### Postharvest Treatment with Phenylalanine Improves Fruit Quality

### Materials and Methods

### Improving Fruit Flavor

Mango—unripe Mango fruits were harvested and dipped in 4-8 mM phenylalanine for a period of 30 seconds. Fruits were stored at 22° C. until ripening (Days 11-15), wherein sensory analysis by a panel of 20 tasters was performed. Further, Brix, and % acidity (calibrated according to citric acid), and firmness (by Newton units) values were determined in 5 different fruits.

Apple—Apple trees were treated with: 8 mM phenylalanine 1 week or 2 weeks before harvest; or with 0.2 prohydrojasmon (also known as ‘blush’). Fruits were harvested from the external area of the tree. After harvest, fruits were stored for 3 months at 0° C., wherein sensory analysis by a panel of 20 tasters was performed, for both slices fruit and for juice extracted therefrom. Brix values were also determined.

Grapes—Muscat grapes and Petit Verdot grapes were treated with 8 mM phenylalanine for: (i) 1 week or 2 weeks; and (ii) 1 week, 2 weeks, or 3 weeks, before harvest, and their combination, respectively. Sensory analysis by a panel of 20 tasters was performed, for the juice extracted from the fruits, and Brix, and % acidity (calibrated according to citric acid) values were also determined. In the case of muscat grapes, intact fruits were also analyzed (e.g., by the panel, Brix, and % acidity).

### Improving Fruit Coloration

Mango or apple trees were treated 1 week or 2 weeks pre-harvest with either 8 mM of phenylalanine or with 0.2% prohydrojasmon (‘blush’). Fruits were harvested from the external area of the tree, wherein fruits are exposed to the sunlight (photon flux of 1,500±200 μmol·m⁻² sec⁻¹). After harvest: (a) mango fruits were stored for 3 weeks at 12° C., and for another week at 22° C. (e.g., shelf life); and (b) apple fruits were stored for 3 months at 0° C., and for another week at 22° C. (e.g., shelf life).

Surface area of the red color was evaluated as percentage, and red intensity was evaluated on a scale of 0-5. Each mango fruit was assessed for percentage of red surface area on fruit for each treatment at different time points (harvest, after cold storage at 12° C. and after shelf life at 22° C.). Similarly, red intensity was evaluated for each mango fruit using a visual rating scale, where 0=no red color, 1=faint red color, and 5=very intense red color. Fifty fruit were evaluated per treatment. The skin color (hue) of 15 mango fruit was measured for each treatment using a CR-400/410 Chromometer (Konicka Minolta, Osaka, Japan) on the equatorial line of each fruit at the reddest point. The hue angle measures color (120 represents green color; 60-70 represents yellow color; 30-40 represents red color).

Chlorophyll, anthocyanin, and flavonoid content were measured by the Multiplex III fluorescence detector (Force A, Orsay, France), which consists of 12 fluorescence signals. The ratios between these signals in different mathematical expressions were interrelated to the fluorescence of major chemical groups, e.g., anthocyanin (FER_RG, the ratio of infra-red emission excited by red or green light), flavonoids (FLAV) and chlorophyll (SER_R). 15 fruits were evaluated for each treatment at the red side.

### Results

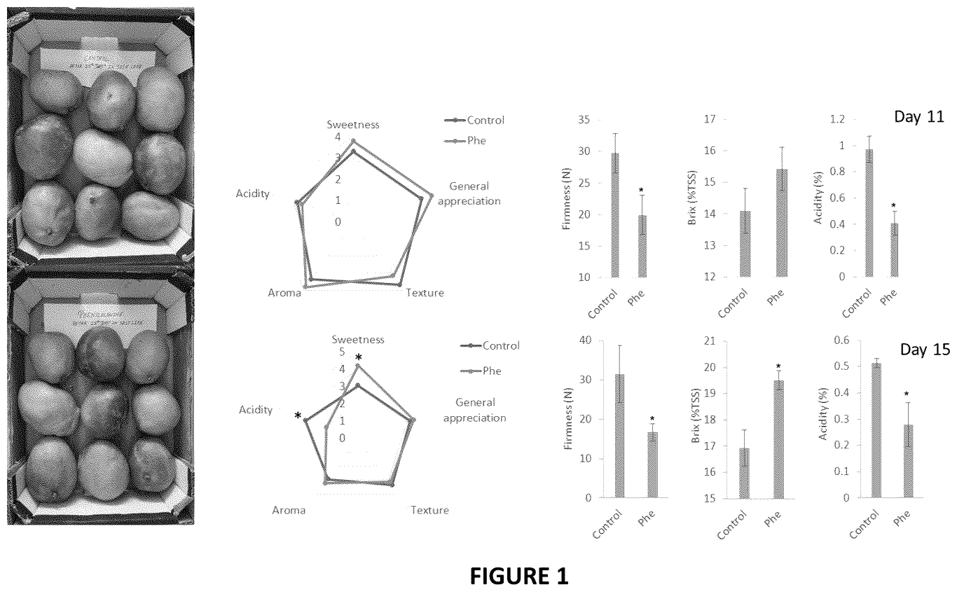

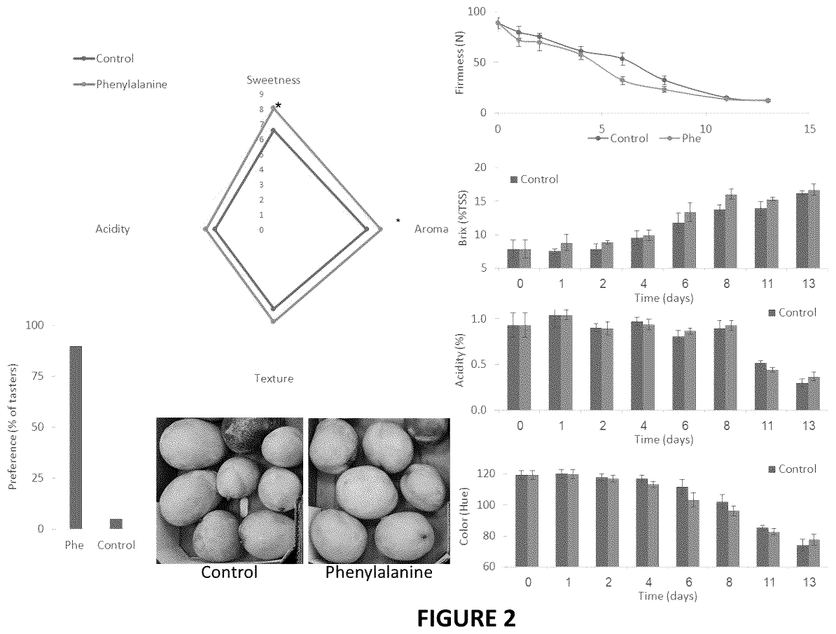

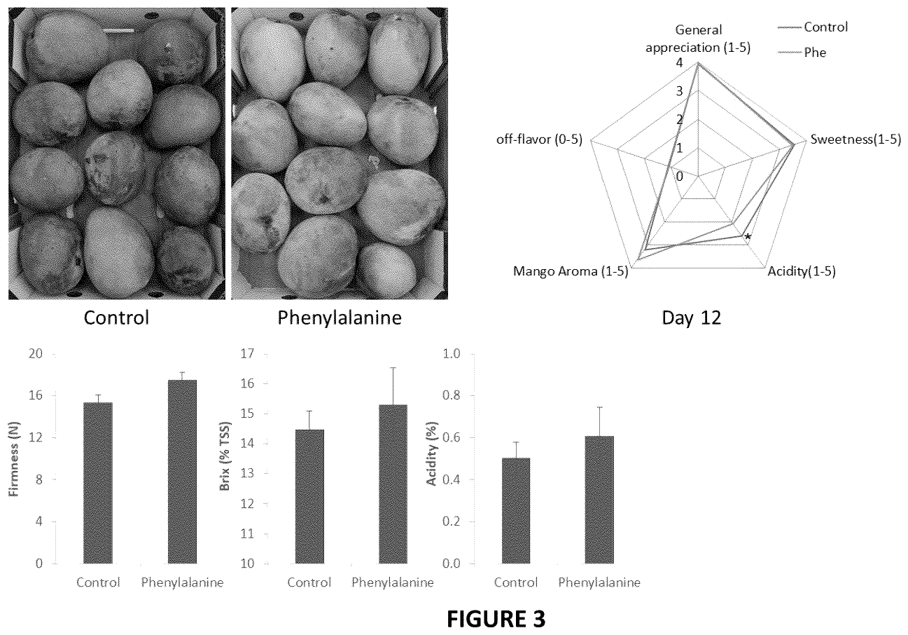

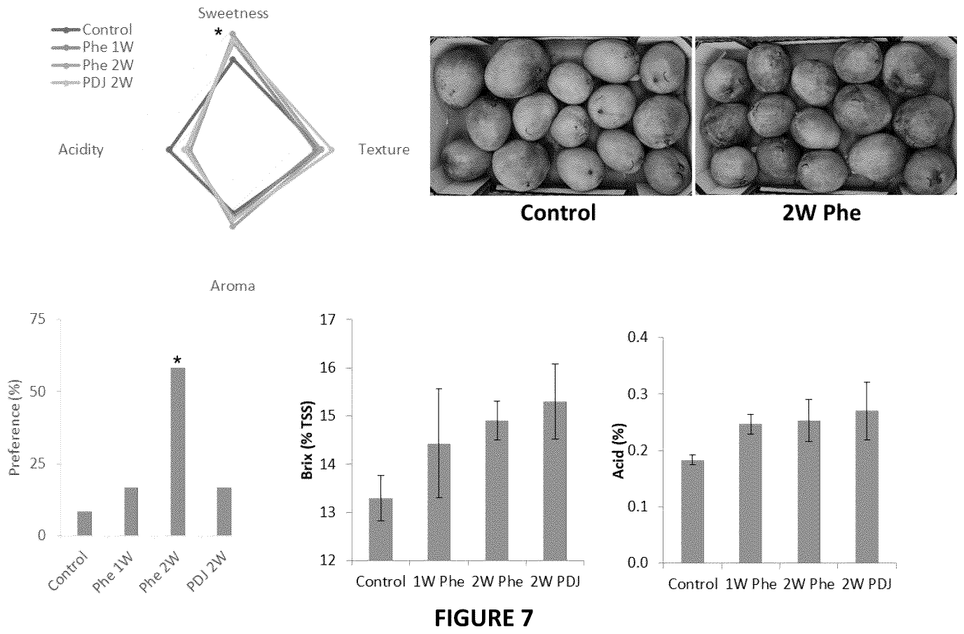

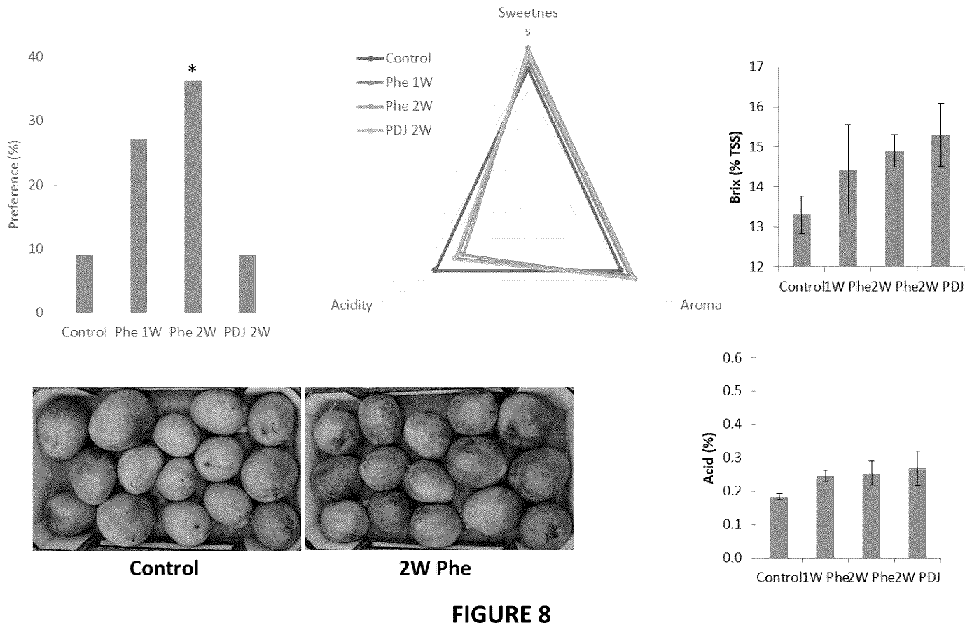

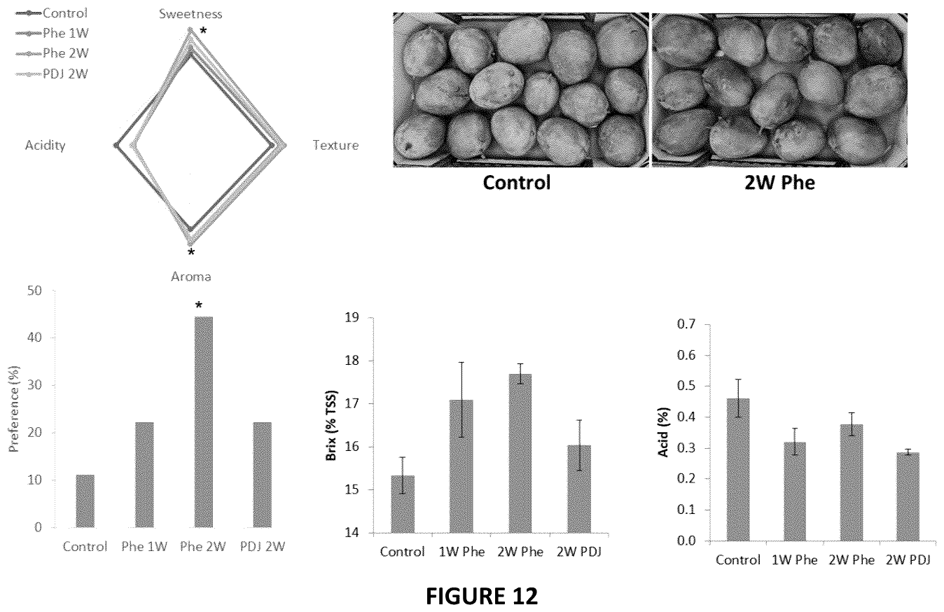

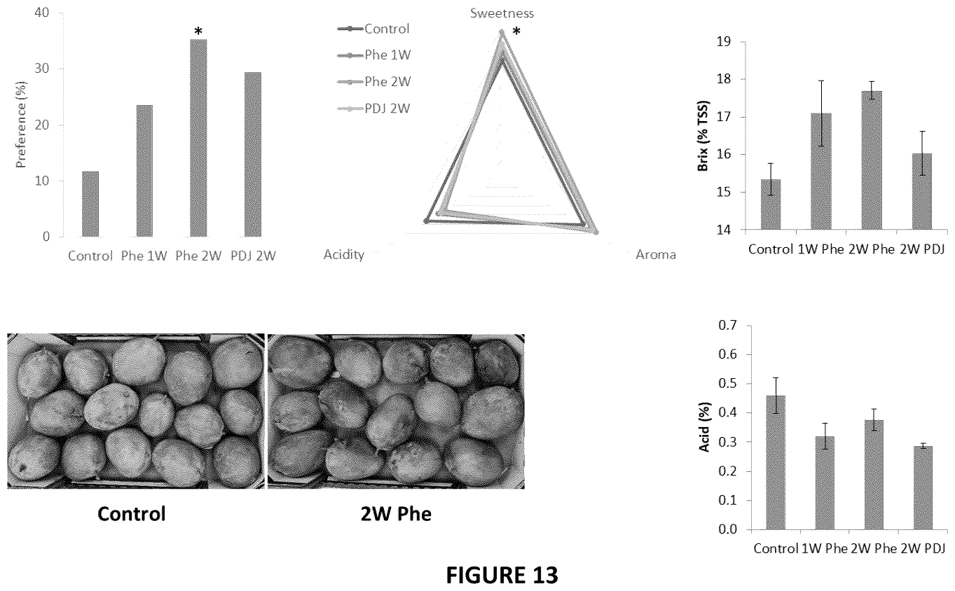

According to the sensory analysis of the tasters' panel, treated mango fruits were found to be of better quality, e.g., sweeter, less acidic, better aroma, firmness, and general appreciation (FIGS. 1-3, 7, and 12). Further, the Brix values determined in the treated mango fruits or in juice extracted or derived therefrom, were found to be greater than the control, as can be seen, in FIGS. 1-3, 7, and 12, and FIGS. 8 and 13, respectively.

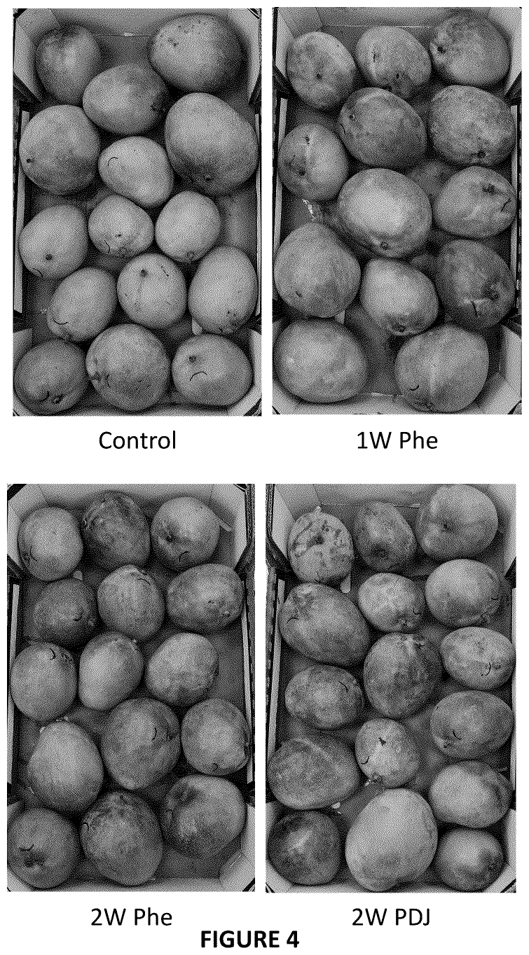

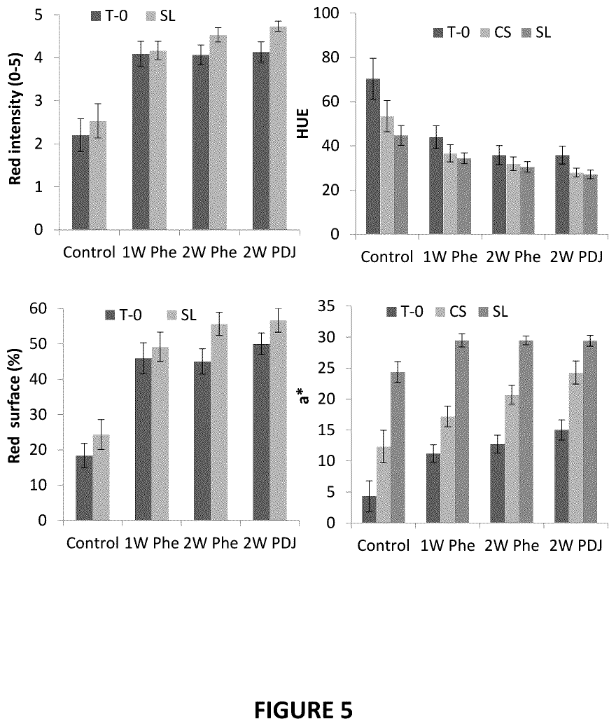

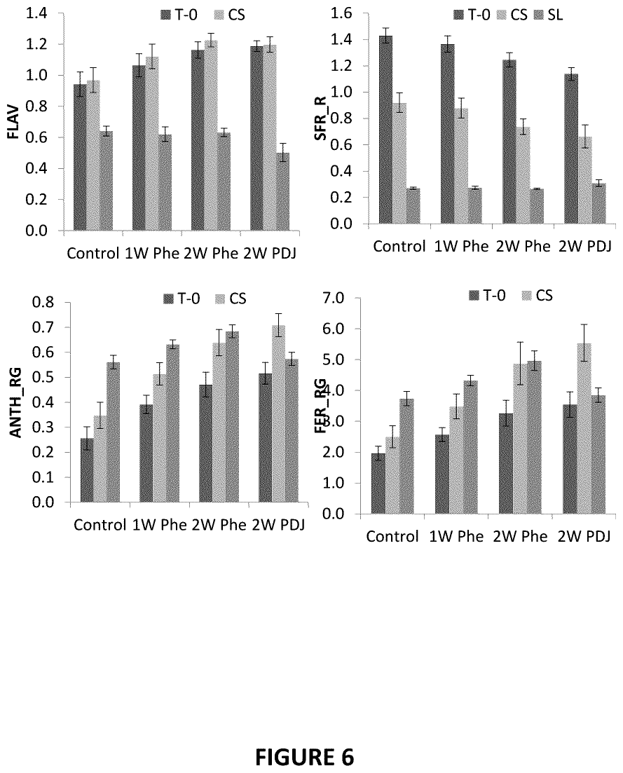

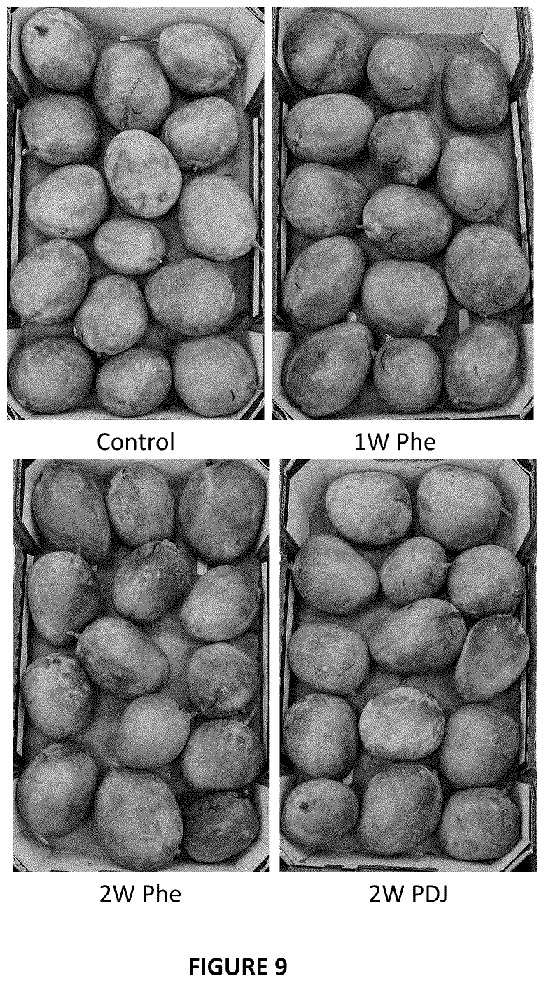

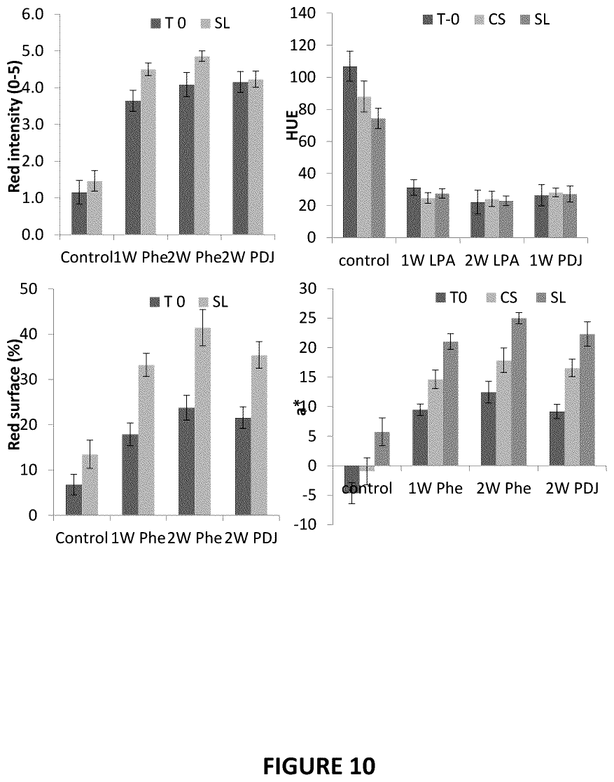

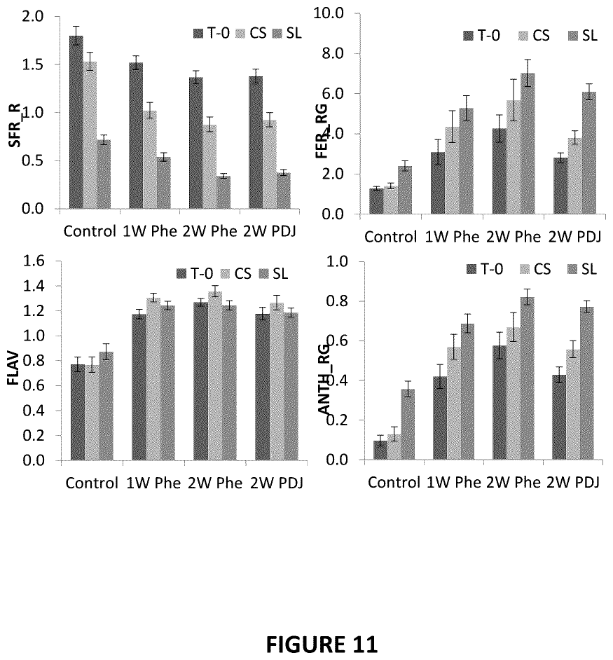

Further, treatment with phenylalanine was shown to effectively induce the formation of red coloration in mango fruits (FIGS. 4-6, and 9-11).

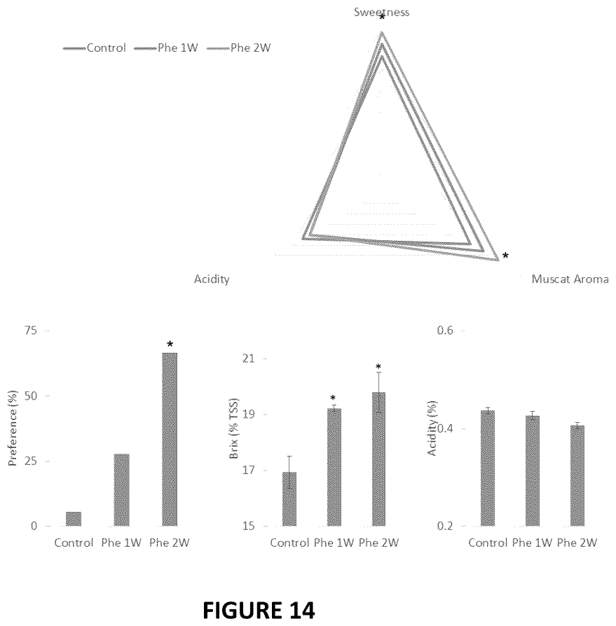

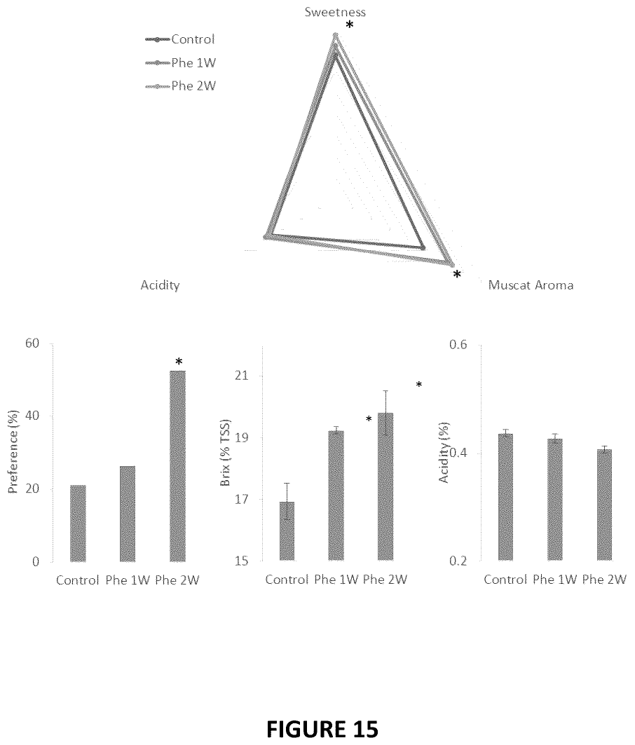

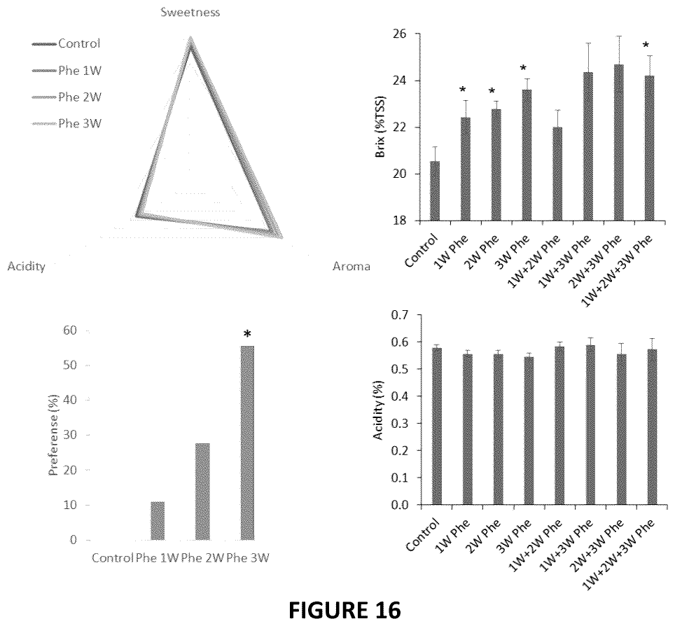

Muscat and Petit Verdot grapes treated according to the herein disclosed method and/or juice extracted or derived therefrom, were found to comprise increased Brix values compared to the control (FIGS. 14-16).

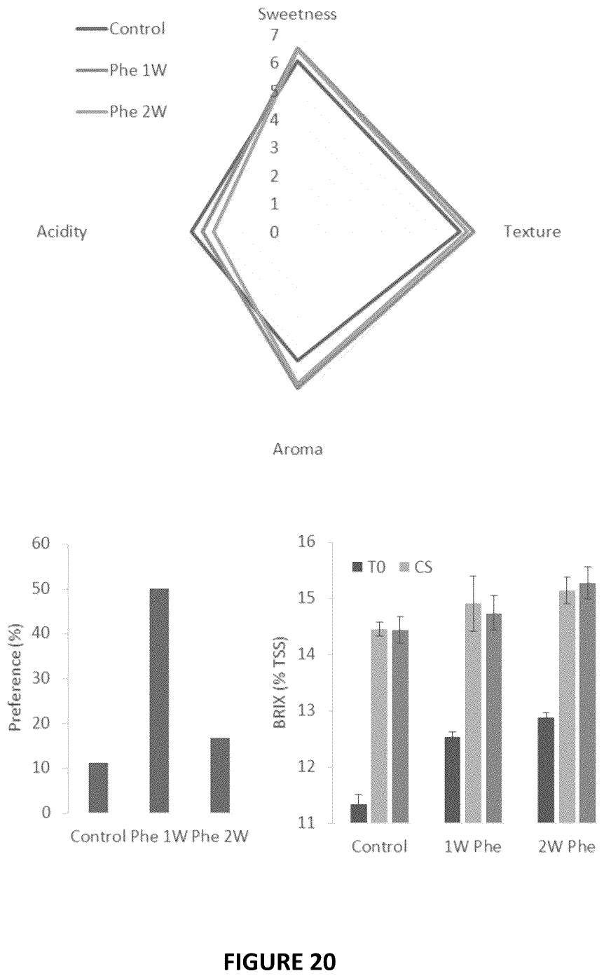

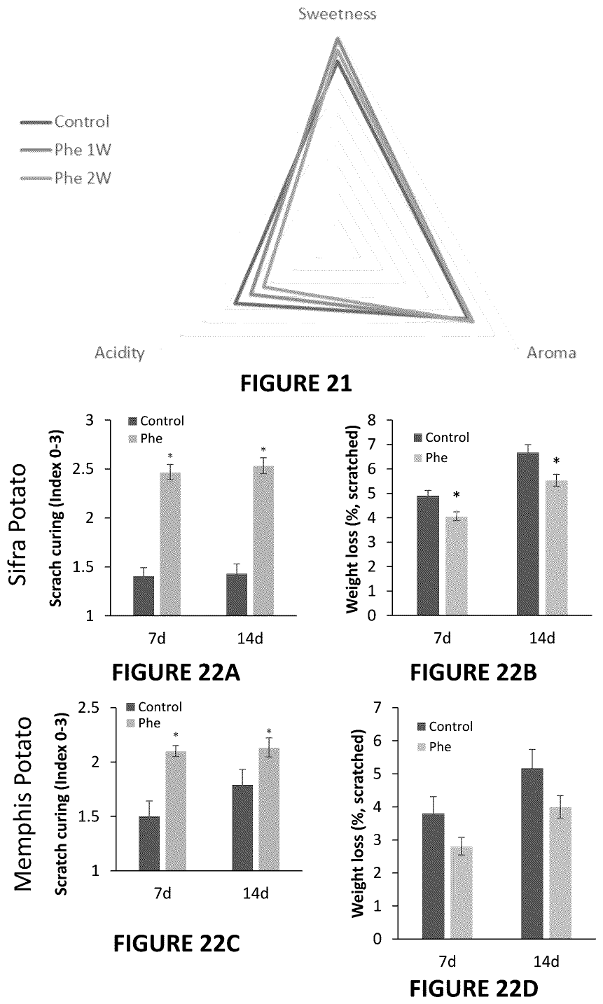

According to the sensory analysis of the tasters' panel, treated apple fruits and/or juice extracted or derived therefrom, were found to be of better quality, e.g., sweeter, less acidic, and with better aroma (FIGS. 20 and 21, respectively). Treated apple fruits were also determined by the panel to have better texture (FIG. 20). Further, the Brix values determined in the treated apple fruits were found to be greater than the control, as can be seen, in FIG. 20.

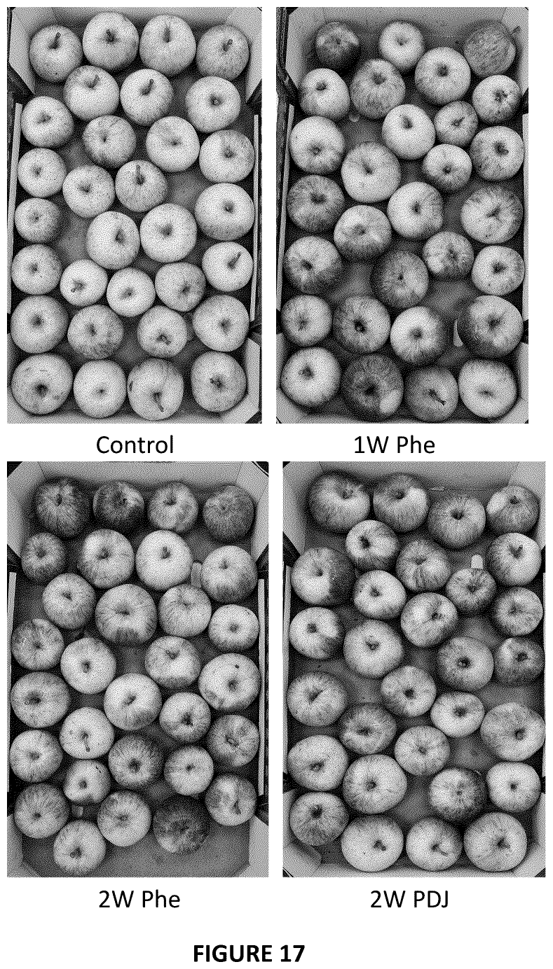

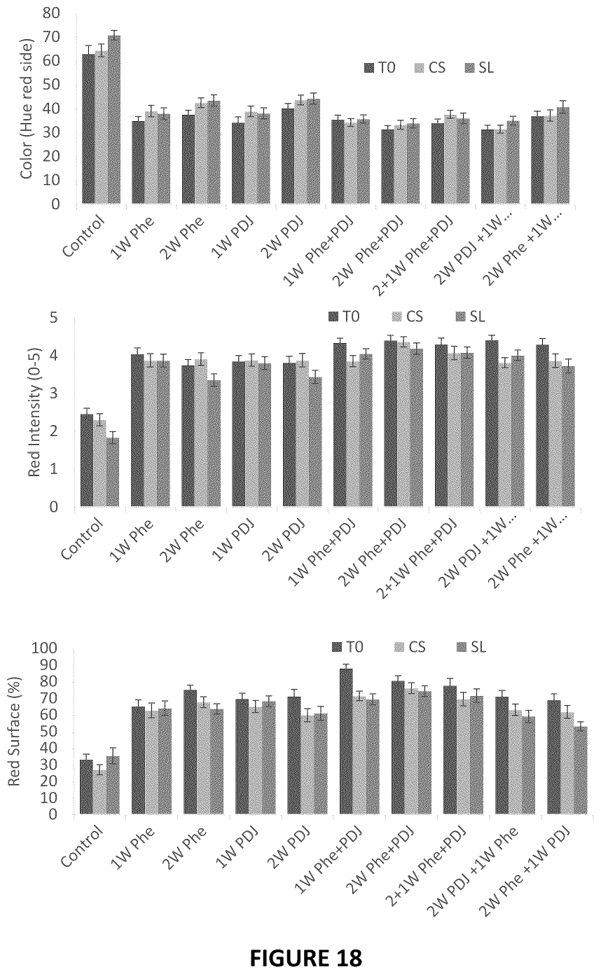

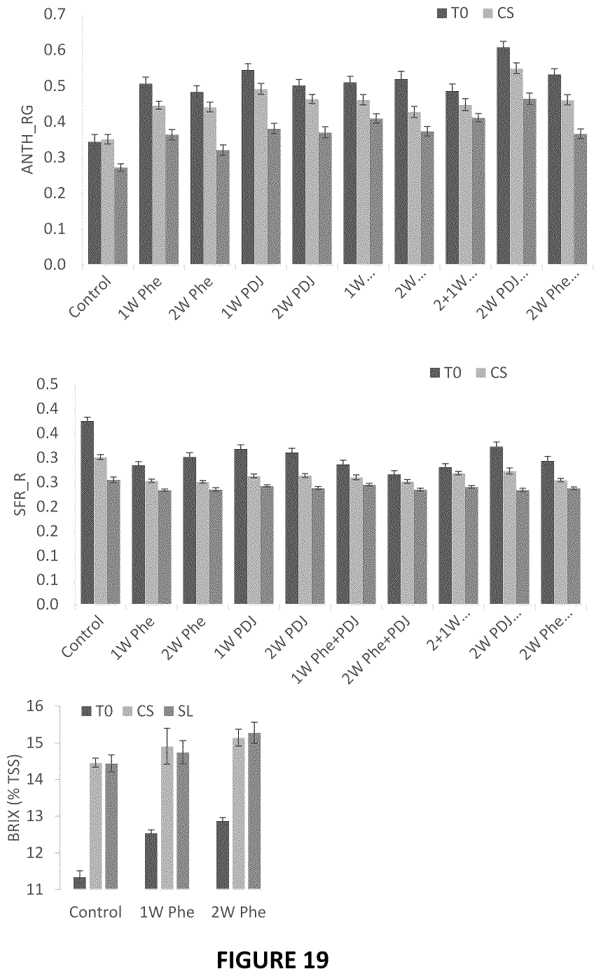

Further, treatment with phenylalanine was shown to effectively induce the formation of red coloration in apple fruits (FIGS. 17-19).

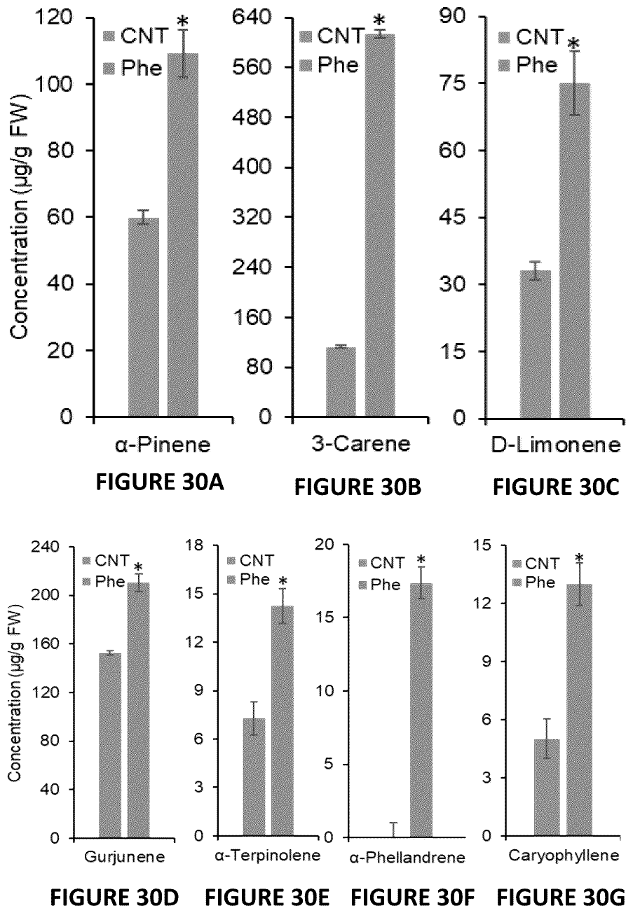

Further, the inventors have shown that postharvest treatment as disclosed herein improves fruit aroma. The investors have dipped Mango fruits, and 11 days after storage at 22° C., the levels of aroma-associated VOCs were determined. Indeed, postharvest treatment with an effective amount of phenylalanine induced a significant increase in the levels of all tested VOCs (FIG. 30). Specifically, the levels of α-Pinene (30A), 3-Carene (30B), D-Limonene (30C), Gurjunene (30D), α-Terpinolene (30E), α-Phellandrene (30F), and Caryophyllene (30G), were found to be significantly elevated in the pulp of treated mango fruits, compared to non-treated fruits.

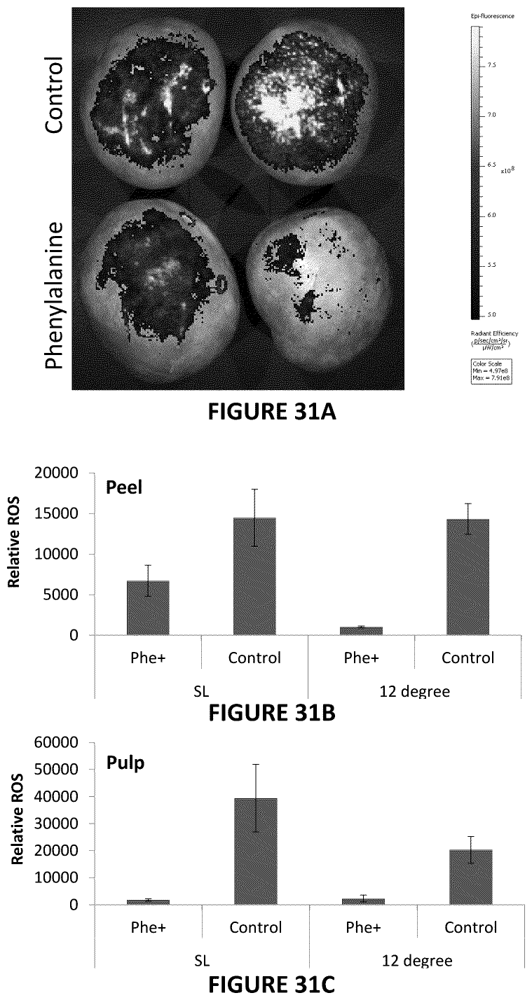

Further, the inventors have shown that postharvest treatment as disclosed herein reduces ROS (reactive oxygen species) accumulation in fruit injured postharvest (FIG. 31). Specifically, the inventors have shown that mango fruits postharvest treated with phenylalanine according to the herein disclosed method, have accumulated substantially less ROS in the peel and in the pulp, compared to a non-treated injured fruit.

### Example 2

### Postharvest Treatment with Phenylalanine Induces Curing in Potato Tuber

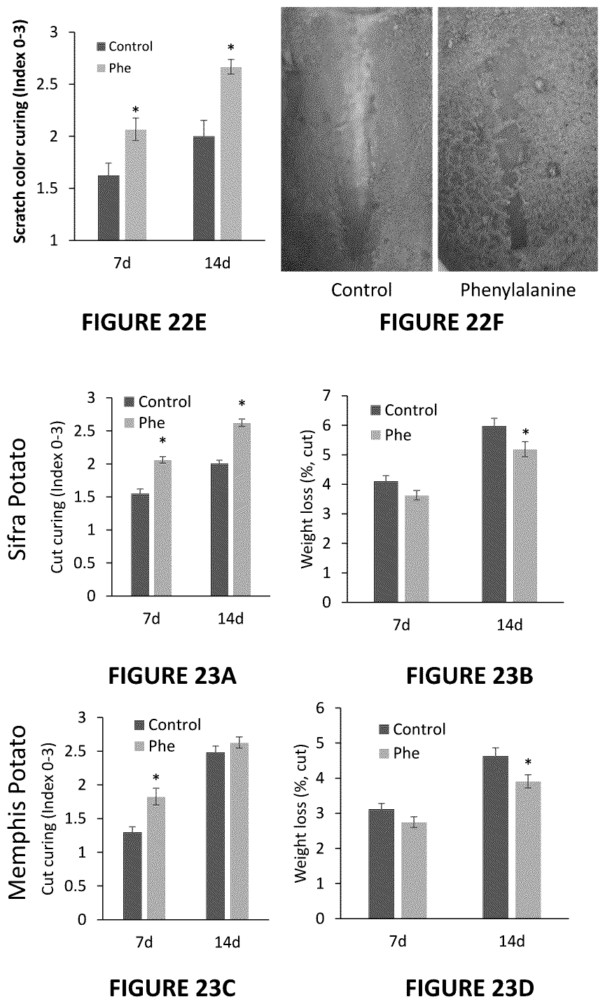

Red (Memphis) and white (Sifra) potato tubers were dipped in water or 8 mM Phe for 1 min, and dried. The tubers were stored at 20° C. for 2 days. Each tuber was scratched (2 cm length, and 1 cm wide) in 3 spots. One week and 2 weeks later the curing of the scratch was evaluated on a scale of 0-3, the recovery of the red color was evaluated on a scale of 0-3, and the weight loss was measured. Scratch curing was significantly improved in both types of potatoes, 7 days, and 14 days post-treatment (FIGS. 22A and 22C). In the red (Memphis) potato, color curing was also significantly improved 7 days and 14 days post-treatment (FIGS. 22E-22F). Weight loss was also shown to be reduced in both types of potatoes (FIGS. 22B and 22D; this improvement was found to be statistically significant in the white potato).

Red (Memphis) and white (Sifra) potato tubers were dipped in water or 8 mM Phe for 1 min, and dried. The tubers were stored at 20° C. for 2 days. Each tuber was cut (2 cm length, 2 cm deep, 2 mm wide) in 3 spots. One week and 2 weeks later the curing of the cut was evaluated on a scale of 0-3, and the weight loss was measured. Cut curing in Sifra potato was improved significantly compared to the control as early as 7 days post-treatment, which further persisted 14 days post-treatment (FIG. 23A). A similar trend was initially observed in Memphis potato 7 days post treatment (FIG. 23C), though to a less extent after 14 days. Further, weight loss was shown to be reduced in both types of potatoes (FIGS. 23B and 23D). This improvement was found to be statistically significant 14 days post-treatment.

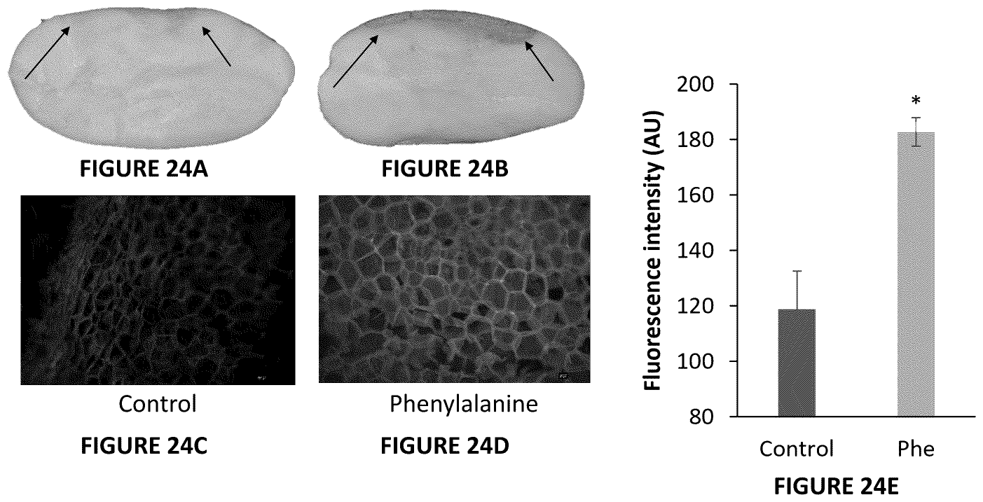

White (Sifra) potato tubers were dipped in water or 8 mM Phe for 1 min, and dried. The tubers were stored at 20° C. for 2 days. Each tuber was cut (2 cm length, 2 cm deep, 2 mm wide). One week later the curing of the cut was documented. Lignin was dyed by Calcofluor white and photographed with a fluorescent microscope, and the fluorescent intensity of 10 repeats was measured by Image J. An increased lignin production was observed in the Phe treated potato (FIGS. 24B, and 24D-24E) compared to the control (FIGS. 24A-24C), one-week post-treatment.

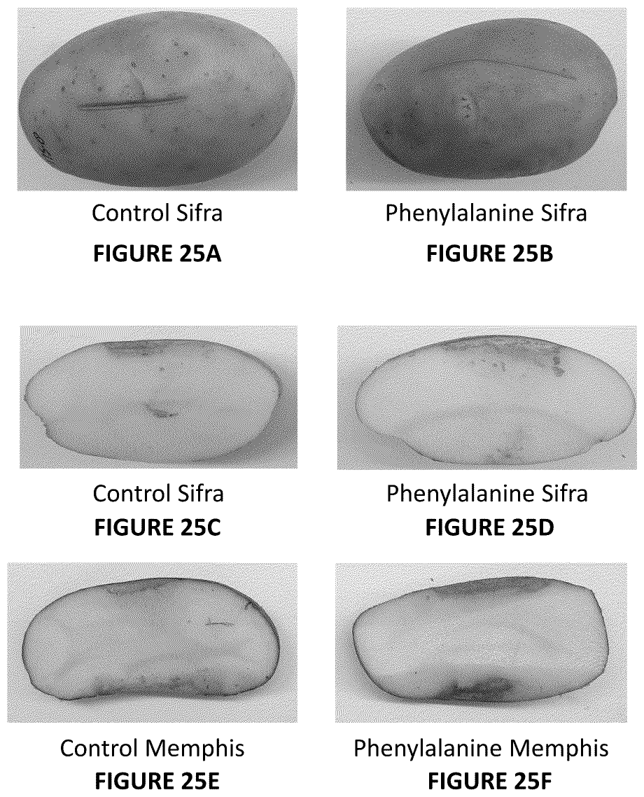

Red (Memphis) and white (Sifra) potato tubers were dipped in water or 8 mM Phe for 1 min, and dried. The tubers were stored at 20° C. for 2 days. Each tuber was cut (2 cm length, 2 cm deep, 2 mm wide). Two weeks later the superficial and internal curing were documented. Curing in both Phe treated Sifra (FIGS. 25B and 25D) and Memphis potatoes (FIG. 25F), either superficial (e.g., external; FIG. 25B) or internal (FIGS. 25D and 25F), was found to be improved compared to control (FIGS. 25A, 25C, and 25E).

### Example 3

### Preharvest Treatment with Phenylalanine Improves Fruit Quality

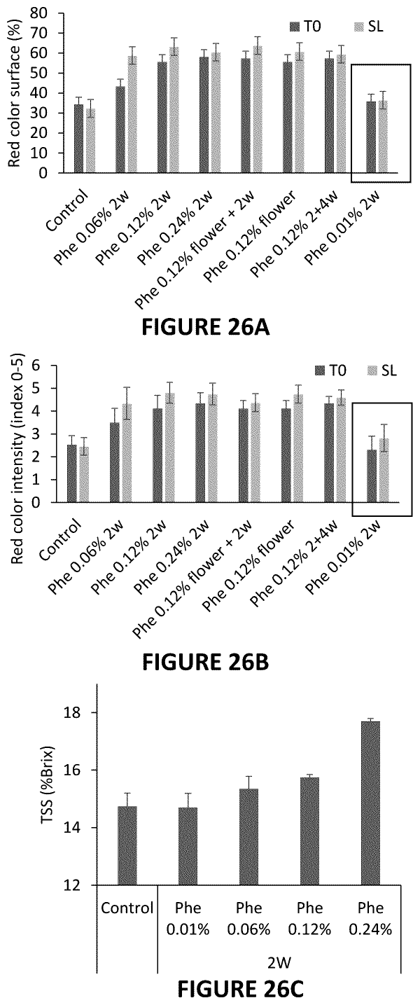

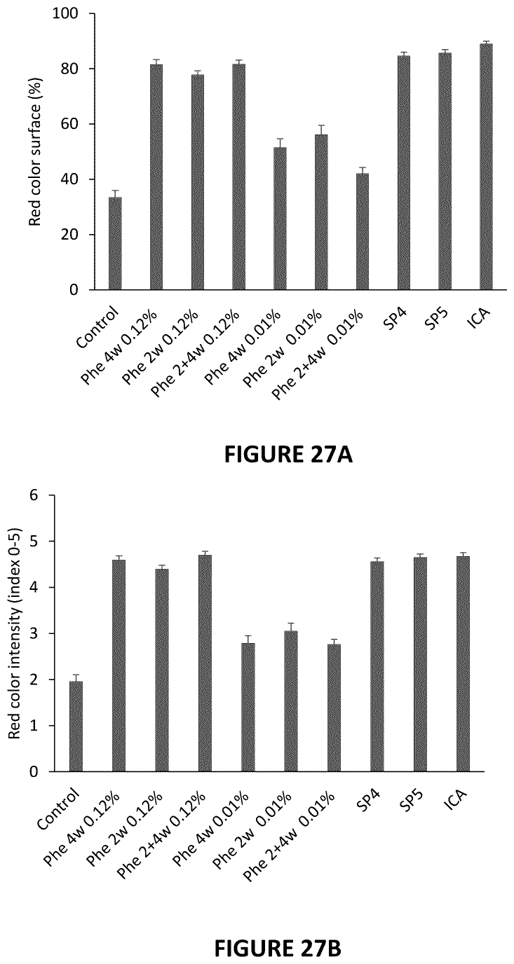

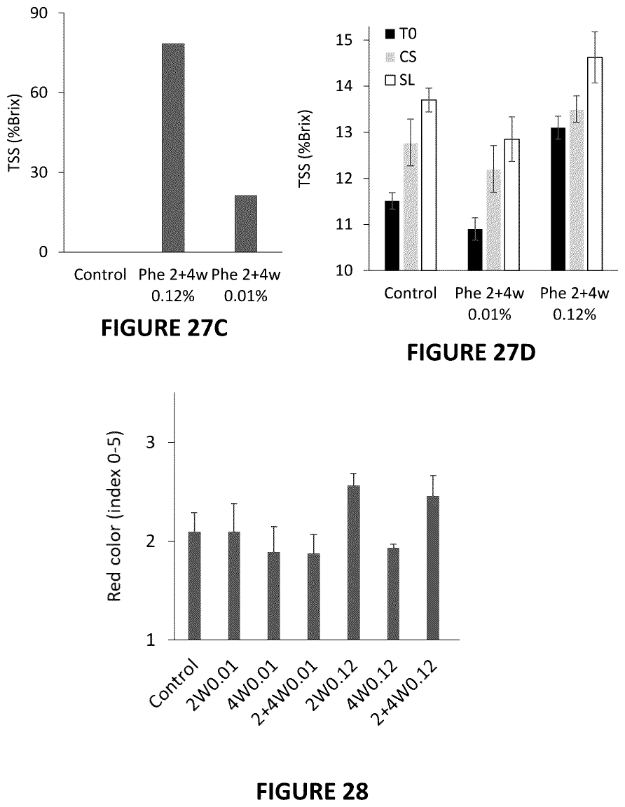

The inventors further showed that preharvest treatment of different types of fruits, e.g., mango (FIG. 26), and apple (FIG. 27), with phenylalanine substantially improved fruit coloration and TSS. Further, improvement of fruit coloration was also shown in grapes (FIG. 28). Further, the desired outcome of improving such fruit quality characteristics was achieved for phenylalanine concentration of 0.06% by weight (˜3 mM) or more, such as 0.012% and 0.24% (approx., 7 mM, and 14.5 mM, respectively). Specifically, phenylalanine at a concentration of 0.01% (equivalent to ˜0.5 mM) was shown to be ineffective in improving: (i) red coloration in any one of: mango, apple, and grapes (FIGS. 26-28); and (ii) TSS levels in mango or apple (FIGS. 26-27). In fact 0.01% was comparable or identical to control in most of these instances, hence cannot be considered relevant to achieve the technical effect being sought for.

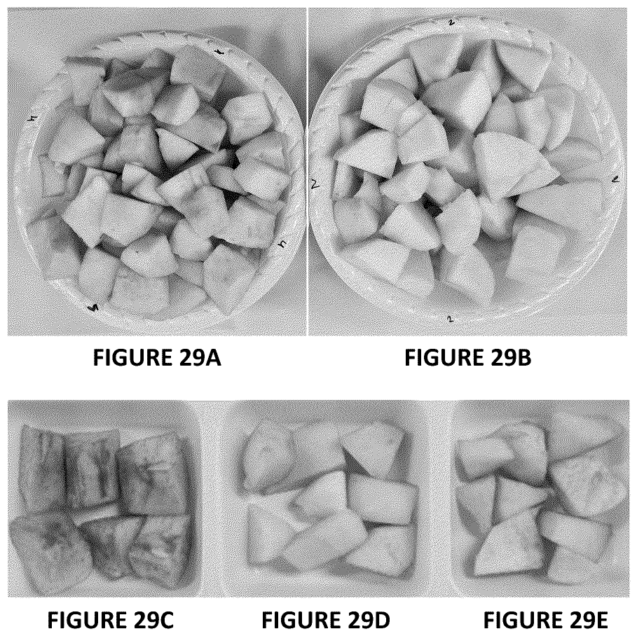

Further, the inventors have examined the effect of preharvest treatment with phenylalanine on enzymatic browning, i.e., oxidation, in a fruit. The inventors showed that enzymatic browning was substantially reduced in sliced apple fruits, treated with 0.12% phenylalanine, either 2 weeks or 4 weeks preharvest (FIG. 29).

Thus, the current data provides a substantial scientific evidence that phenylalanine at concentrations ranging from 0.06% to 0.24% (˜3 mM to 14.5 mM), are suitable for improving fruit quality.

While certain features of the invention have been described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for improving any one of: flavor, coloration, curing to damage, or a combination thereof, of a plant material, foliage of a plant comprising said plant material, or both, comprising pre-harvest or post-harvest treating a plant material with an effective amount of phenylalanine or an analog thereof.

2. The method of claim 1, wherein improving does not comprise increasing due to a reduction in any one of: said flavor, coloration, curing, or a combination thereof, being induced by a plant pathogen.

3. The method of claim 1, wherein said improving flavor comprises: increasing the amount of anthocyanin, flavonoid, or both, in said plant material or a juice extracted therefrom.

4. The method of claim 1, wherein said improving flavor comprises: increasing Brix value, reducing acidity value, increasing aroma, or both, in said plant material or a juice extracted therefrom.

5. The method of claim 1, wherein said improving coloration comprises inducing red coloration, reducing the amount of chlorophyll, increasing the ratio of anthocyanin to chlorophyll, or any combination thereof, in said plant material.

6. The method of claim 1, wherein said plant material comprises any one of fruit and tuber.

7. The method of claim 1, wherein said damage is induced by an abiotic agent.

8. The method of claim 7, wherein said abiotic agent comprises a physical or a mechanical injury.

9. The method of claim 1, wherein said improving the curing comprises: increasing scratch curing, increasing cut curing, increasing scratch color curing, reducing weight loss %, increasing lignin production rate or suberin production rate or both, or any combination thereof, of said plant material.

10. The method of claim 1, wherein said effective amount of phenylalanine or an analog thereof is above 2 mM.

11. The method of claim 1, wherein said effective amount of phenylalanine or an analog thereof ranges from 4 mM to 20 mM.

12. The method of claim 1, further comprising a step of providing a preharvest abiotic stress condition to said plant material for a period of time ranging from 1 to 30 days, and optionally wherein said abiotic stress condition comprises light, radiation, temperature, lack of nutrient or water, or any combination thereof.

13. (canceled)

14. The method of claim 1, further comprising a step of selecting a plant material in need of a treatment using said phenylalanine or an analog thereof.

15. The method of claim 14, wherein said selecting comprises determining an amount of a phytochemical in said plant material compared to a predetermined threshold, wherein a plant material comprising said phytochemical in an amount greater than said predetermined threshold is suitable for pre-harvest or post-harvesting treating with an effective amount of phenylalanine or an analog thereof.

16. The method of claim 15, wherein said phytochemical is selected from the group consisting of: a flavonoid, an anthocyanin, a pigment, and any combination thereof, and optionally wherein said pigment comprises chlorophyll.

17. (canceled)

18. The method of claim 15, wherein said selecting comprises determining total soluble solids (TSS) % or dry matter, or TSS/Acid in said fruit, wherein a fruit comprising at least 5% less TSS % or TSS/Acid, is suitable for pre-harvest or post-harvest treating with an effective amount of phenylalanine or an analog thereof.

19. The method of claim 1, wherein said treating comprises: drenching, dipping, soaking, injecting, spraying, coating, or any combination thereof.

20. The method of claim 1, wherein said treating is in: an open field, a greenhouse, a storage facility, or any combination thereof.

21. The method of claim 1, wherein said improving is compared to control plant material.

22. The method of claim 1, wherein said plant material comprises a vegetable or fruit, and optionally wherein said vegetable comprises: a stalk, a leaf, a root tuber, a stem tuber, or any combination thereof.

23. (canceled)
